(19) United States
(12) Patent Application Publication
(10) Pub. No.: US 2021/0024164 A1
(43) Pub. Date: Jan. 28, 2021

(54) TWO-TIERED STRUCTURAL FRAME FOR A THREE-WHEELED CARGO BIKE

(71) Applicant: Juggernaut Cargo, Inc., Denver, CO (US)

(72) Inventor: Jeffrey Mauck, Denver, CO (US)

(21) Appl. No.: 16/523,844

(22) Filed: Jul. 26, 2019

(51) Int. Cl. B62K 5/06; B62K 5/05; B62K 5/08; B62K 19/06; B62K 19/40; B62K 19/46; B62H 1/02; B62K 19/18

(52) U.S. Cl. CPC B62K 5/06; B62K 5/05; B62K 5/08; B62K 19/06; B62K 2005/001; B62K 19/46; B62H 1/02; B62K 19/18; B62K 19/40

(57) ABSTRACT

Embodiments of the present invention include to a two-tier structural frame for a three-wheeled cargo bike. The structural frame can be the platform for the entire bike and includes both steering and suspension parts. The frame of the bike and its related suspension and steering parts provide stability, durability, and comfort while in motion under human pedal power, as well as motion from a hybrid of human pedal and electric-assisted power sources.

### CROSS REFERENCE TO RELATED APPLICATIONS

This application is related to U.S. Provisional Patent Application Ser. No. 62/448,837 filed on Jan. 20, 2017, Taiwanese Patent Application No. 107102134 filed on Jan. 19, 2018, and PCT Patent Application No. PCT/US2018/014403 filed on Jan. 19, 2018, which are each incorporated by reference herein in their entireties.

### FIELD OF INVENTION

The invention is related to a two-tier structural frame for a three-wheeled cargo bike. The structural frame is intended to be the platform for the entire bike and is related to steering and suspension parts.

### BACKGROUND

Cargo bikes have been around for decades in many parts of the world. The United States currently does not have an American cargo bike company that designs and manufactures a three-wheeled bike with the cargo in the front of the bike for the American market.

Cargo bikes exist in American factories for carrying tools. These are cargo “trikes” where the materials are carried in the back of the bike. Other cargo bikes in the United States are designed and constructed by hobbyist and do not take into consideration function, safety, and efficient or smooth travel.

These and other issues presented by current designs can be addressed with the present invention.

### SUMMARY

The present invention is designed to meet the needs of people living in cities in the United States, and around the world. One aspect of the invention is directed to a three-wheeled bike that is stable, safe, and easy to turn. Other considerations in the design and implementation of the invention are the economics and ease of production. The present invention can be mass-produced for consumers in North America, and beyond.

A majority of American cities sprawl out greater distances and are less compact than most cities around the world. A benefit of the present invention is that it can be used to travel long distances, at greater speeds than prior art designs, and still be narrow enough to fit in a one-way bike lane. The present invention can be used to travel comfortably over paved or unpaved surfaces while maintaining structural stability, in part because of the two-tiered frame design.

The frame of embodiments of the present invention can absorb and distribute forces during straight-line travel and while turning. The two-tiered frame allows the suspension system to operate correctly and offer the bike its functionality and durability qualities. The a-arms and kingpin of embodiments of the invention enable the wheels to spin into the direction of a turn and not slip or skip sideways when traveling around a curve. Specifically, the kingpin and a-arms permit the front two wheels/tires to turn at different angles such that they can rotate at the same rotational velocity and not slip or skip. The rod and plate steering mechanisms of embodiments of the invention assure firm anchorage to the kingpin, which holds the axles and wheels/tires. Optional shocks on each side of the frame control vibratory motion, offer resistance in the form of unwanted bounce, and keep the tires contacting the ground. The a-arms link both sides of the bike on the top and bottom of the frame rail. The a-arms can be hinged suspension linkages. These elements can be any suitable shape. In some embodiments, the a-arms can be u-shaped and include two or more pinned connections at each end. A purpose of the a-arm is to link the kingpin, the frame, the suspension, and the axle that carries the wheel. A-arms interconnect the shocks to the top tube and the bottom tube of the frame. In some embodiments, the system includes an upper a-arm and a lower a-arm. The lower a-arm connects to the bottom of the shock at a piston mount, while the fixed shock mount at the top of the shock are shock cleats that are linked (directly or indirectly) to the top frame tube/rail.

The design of the suspension, frame, and steering mechanism is based on their close relationship to one another, which was established using the Ackermann equation in a cargo bike. The present invention is believed to be the first front-wheel design cargo bike with Ackermann steering and a suspension system.

In the Ackermann equation, the geometry is validated only when the wheels and axles are organized as radii of circles with a common central point in a turned position. The rear wheel of the present invention is fixed, while the front two wheels are not fixed and can turn. From this fixed point (at the rear axle) a line is drawn. Then two lines are drawn from each of the front axles back to a central point from the rear axle. In a computer model, the equation is proven when all circles drawn can be traced to a common point.

A successful “real world” result happens when the outside wheel is positioned at a greater angle (β) (i.e., between about 90° and about 180°, or in some embodiments between about 105° and about 120°, or about 95°, about 100°, about 105°, about 110°, about 115°, about 120°, about 125°, about 130°, about 135°, about 140°, about 145°, about 150°, about 155°, about 160°, about 165°, about 170°, or about 175°) than the angle for the inside wheel (α), while turning, with relation to the Ackermann point as illustrated in FIG. 2 when the wheels are turning right. One skilled in the art would understand a similar relationship when the wheels are turning left, where the outside wheel would be at an angle (i.e., between about 0° and 90°, in some embodiments between about 15° and about 30°) that is less than the angle of the inside wheel.

Angled wheel positioning, in some embodiments, and the incorporation of shocks create a system that works to keep the operator safely positioned on the vehicle and counterbalance the forces going into a turn. In an embodiment of the present invention, the top and bottom a-arms on the cargo bike can be vertically offset between about 0.75 inches and about 1.5 inches, or in some embodiments about 1.0 inch, or about 0.8 inch, about 0.85 inch, about 0.9 inch, about 0.95 inch, about 1.05 inch, about 1.1 inch, about 1.15 inch, about 1.2 inch, 1.25 inch, about 1.3 inch, about 1.35 inch, about 1.4 inch, or about 1.45 inch, when viewed from the top down. This offset helps achieve a steep angle on the kingpin. The kingpin has at least one bolted attachment at the top center and the bottom center of each a-arm. The bottom of the kingpin is angled outward further toward the front of the bike than the top of the kingpin. This configuration provides faster steering and requires less effort to steer the cargo bike. The relationship between the top and bottom a-arms works in the same manner as the head tube and fork to facilitate the steering of a standard two-wheel bicycle.

Further, the configuration and positioning of the kingpin and a-arms work to provide a design that assists the wheels/tires to angle from the tire patch to the top of tire and firmly plant the wheels/tires on the road surface while cornering, thus allowing the bike to steer without having the tires skidding and slipping during the turn.

In some embodiments, a kingpin connection plate is positioned on the bottom of each kingpin and interconnected to a tie rod. In some embodiments, the tie rod is a long tie rod that extends across the cargo frame from right side to left side, or right kingpin to left kingpin. In other embodiments, each kingpin connection plate is interconnected to short tie rod that is interconnected to a steering swivel arm, which is then interconnected to a long tie rod. Thus, in some embodiments there is one tie rod extending across the bottom of the cargo frame from the right kingpin connection plate to the left kingpin connection plate. In other embodiments, there are three tie rods (two short ties rods and one long tie rod) and two steering swivel arms extending across the bottom of the cargo frame from the right kingpin connection plate to the left kingpin connection plate. In the embodiments with three tie rods and two steering swivel arms, the tie rods move in harmony with the a-arms.

In some embodiments, the frame has a non-metal belt as a part of the steering system. The frame can also have a drive belt that is a non-metal belt. Either or both belts (e.g., the drive and steering belts) can be a carbon belt or a carbon belt system (sprockets, belt, and/or crankset) in various embodiments and can be a Gates Carbon Drive, where the carbon belt is grease-free and rust-free, in some embodiments.

The arrangement of the suspension components and the sizing of each are dependent on the bike's overall frame width, as well as the kingpin on center-to-center width.

The two-tiered frame is an integral part of the success of this offset between the top and bottom a-arms. The bottom and top tubes are mathematically positioned to be spaced apart based on the height of the kingpin. A-arms are bolted to water-jet-cut plain-steel cleats, which are adhered to the bike with welds or other joining methods.

It is another aspect of the present invention to provide a two-tiered frame design having two levels of frame structure with one frame positioned over or above the other. The on-center locations (i.e., the location at about the middle of the a-arm in relation to the height of the bike) of the top and bottom tubes are dictated by the length of the kingpin. In some embodiments, center tubes connect the front and back of the bike. The two-tiered frame in the front extends to the seat post via the center top and bottom frame tubes where the rider is positioned. In one embodiment, angled vertical supports connect the top and bottom frames together and ensure they are spaced apart the appropriate distance. In another embodiment, each side only has one angled vertical support because the front of the frame is curved and the top tube curves down to interconnect with the bottom tube; thus, the downward connecting portion acts as a vertical support.

It is one aspect of the present invention to provide an aesthetically pleasing design. There are two aesthetic qualities of the frame design. First, the side supports in the front of the bike can be at the same angle as the seat post. Second, the look of the frame can be carried from the front of the bike to the back of the bike for a homogeneous look.

Another aspect of the present invention is a platform that offers the user flexibility regarding the use of the platform. Specifically, the occupant basket is not required to be a permanent part of the overall structure, which means an occupant basket can be incorporated for people or items people may want to carry or the occupant basket can be removed entirely. The two-tiered frame provides the ability to manufacture the occupant basket from a variety of materials including, but not limited to, steel, aluminum, wood, titanium, other metal, composite, carbon fiber, or polycarbonate. The strength of the two-tiered frame allows for any configuration of basket to be fastened to the frame, without the need for the basket to be overdesigned. Thus, an occupant basket only needs to have enough strength for itself and its occupants. Additionally, the rest of the bike does not rely on the basket for strength. Thus, a basket can be a lightweight material (e.g. composite, plastic, etc.).

Additionally, the two-tiered frame design can be used without the basket in a flatbed mode for carrying cargo. Thus, the frame itself can be used for transport as a flatbed with a sheathing over the frame. The frame can be covered in steel, aluminum, wood, titanium, or polycarbonate to take on the utility of a traditional flatbed truck. Accordingly, the user can carry cargo as high or heavy as he/she can safely maneuver.

One aspect of the invention is to provide a bike that is stable. Bike stability is accomplished by having a frame that is low to the ground and, therefore, has a low center of gravity. Additionally, the material of the bike frame can be steel, aluminum, other metal, carbon fiber, or other composite material, where the overall weight is on the bottom of the bike.

It is another aspect of embodiments of the present invention to provide a frame with an improved rear triangle. The rear triangle interconnects the seat post to the rear wheels/tires. Thus, the seat post completes the rear triangle, which is capable of housing multiple different types of tires. The bike, according to embodiments of the present invention, can have a street-oriented tire that is thin and smooth, much like a traditional road bike tire. The rear triangle can also accommodate a mountain bike tire, sand tire, or snow tire, which is thicker and rougher than the street-oriented tire. Further, the rear triangle can accommodate a hybrid tire sized in between a road tire and mountain bike tire.

In some embodiments, the frame has a bent tube design, which saves assembly time and welding material. Thus, the frame is comprised of less tube pieces. In some embodiments, the bent tube design includes tube ends that are laser cut, which enables the end shape to be more exact and to fit better with the other tubes than tube ends of prior art designs where the ends are rough and then welded together. Accordingly, the laser cut ends enable full-metal contact between the tube end of one tube and the interconnection point on the second tube. Moreover, by having full-metal contact, the parts fit together perfectly such that there are no voids, which means little to no joining material (e.g., glue, adhesive, solder, welding, etc.) is shot into any voids. Accordingly, the left upper tube can be one continuous piece, the right upper tube can be one continuous piece, the left lower tube can be one continuous piece, and the right lower tube can be one continuous piece.

In some embodiments, the width of the rear triangle of the bike can accommodate a rear hub for an e-assist system, i.e., an electric motor to propel one or more wheels of the bike. Also, dropouts, i.e., one or more tabs typically made of metal, on the drive side of the bike near where the rear wheel, are anchored in the frame, are adjustable, and remove any tension in the belt drive system. In order to add tension to the drive belt, an adjustable dropout allows the rear wheel to be slid or pivoted into place and fastened. By moving the wheel away from the crank set, chain tension is increased on the dropout by hand-turning the tensioner.

It is another aspect of embodiments of the present invention to provide a bike with side-mounted suspension on the front two wheels/tires. An advantage of the two-tiered cargo frame design is that the suspension is mounted on the side of the cargo frame. The a-arm suspension can be attached (e.g., bolted) onto cleats that are attached to the top and bottom rails/tubes of the frame, which allows the frame to be lower to the ground and flatter in turns than prior art designs. This system is in stark contrast to the tilting or leaning cargo bike offerings from Butchers & Bikes (as described in WO 2015/067760) or Veleon systems. Additionally, the side-mounted suspension keeps the frame lower to the ground, which keeps the occupants and cargo flatter and more stable throughout turns and curves. The side suspension also flattens the travel for the center of the bike relative to the height of the bike, meaning that the bike does not tilt when going into a corner or turning. Therefore, the cargo does not tilt.

In one embodiment, on the bottom of the bike, located under the cargo frame, is the steering mechanism consisting of steel, aluminum, or other metal or composite rods attached to stainless steel or other metal water-jet-cut parts.

In some embodiments, the bike is foldable for storage purposes. Accordingly, the cargo storage compartment (i.e., the cargo basket) may be removed and the frame of the bike folded. In additional or alternative embodiments, the bike can be designed to be stored upright on a portion of its frame, for example on a front portion of the frame, with the wheels in the air. Thus, the bike may have a rubber bumper on the front portion of the bike frame and/or cargo storage compartment. The rubber bumper contacts the ground when the bike is stored in the upright position on its front, meaning positioned with the front of the bike on the ground and the rear tire up in the air and away from the ground. The bike can have two or more rubber bumpers such that only the rubber bumpers contact the floor and the bike is stored in a more stable position by using more than one bumper. The bumper may also protect the bike and cargo if the front of the bike hits an object.

In some embodiments, the bike has one or more kickstands such that the bike can be positioned upright with its wheels on the ground without leaning against another object. The kickstand can be stored flush against or along a portion of the frame when not in use and can be flipped down to contact the ground when in use. Thus, the kickstand extends from a portion of the frame to the ground when in use. The kickstand can have two positions: a first stored position and a second extended position of use. The kickstand can be any material known in the art, including, for example, metal, carbon fiber, plastic, wood, etc., and combinations thereof.

In some embodiments, a two-tiered vehicle frame is provided comprising: a top tube; a bottom tube; steering post, wherein the top tube and the bottom tube extend from the front of the frame to the steering post; at least one rear tube; a seat post, wherein the at least one rear tube connects the steering post to the seat post; rear triangle, wherein the rear triangle attaches to the seat post; a cargo storage area located between a first side of the frame and a second side of the frame; and steering system comprising: a first top a-arm, wherein the first top a-arm is located on the top tube; a first bottom a-arm, wherein the first bottom a-arm is located on the bottom tube; a second top a-arm, wherein the second top a-arm is located on the top tube at a location across from the first top a-arm; a second bottom a-arm, wherein the first bottom a-arm is located on the bottom tube at a location across from the first bottom a-arm; a first kingpin, wherein the first kingpin attaches between the first top a-arm and the first bottom a-arm; and a second kingpin, wherein the second kingpin attaches between the second top a-arm and the second bottom a-arm.

In various embodiments, a material for at least one of the top tube, the bottom tube, the steering post, the at least one rear tube, the seat post, the rear triangle, the first top a-arm, the first bottom a-arm, the second bottom a-arm, the second bottom a-arm, the first kingpin, or the second kingpin is selected from the group consisting of aluminum, titanium, steel, an alloys thereof, a composite material and combinations thereof. In additional or alternative embodiments, the steering system further comprises: a triangle plate; a first rod, wherein the first rod connects the first kingpin to the triangle plate; a second rod, wherein the second rod connects the second kingpin to the triangle plate; a first diamond plate, wherein the first diamond plate connects to the triangle plate; at least one tie rod; a second diamond plate, wherein the second diamond plate connects to the first diamond plate with at least one tie rod, and wherein the second diamond plate connects to the steering post.

In additional or alternative embodiments, the frame further comprises at least one support tube. In various embodiments, the top tube and the bottom tube are in the same vertical plane. In some embodiments, the bottom tube and the top tube are not in the same plane, and wherein the bottom tube is inward by between about 0.125 inches and about 0.75 inches from a centerline of the top tube and a centerline of the bottom tube.

In various embodiments, a bike is provided comprising: a forward end; a rear end; a first forward wheel proximate the forward end, wherein the first forward wheel can turn right and left; a second forward wheel proximate the forward end, wherein the second forward wheel can turn right and left; a rear wheel proximate the rear end, wherein the rear wheel is fixed and cannot turn; a frame comprising: an upper right tube proximate the forward end of the bike; an upper left tube proximate the forward end of the bike; an upper tube positioned between and interconnected to the upper right tube and the upper left tube; a lower right tube proximate the forward end of the bike; a lower left tube proximate the forward end of the bike; a lower tube positioned between and interconnected to the upper right tube and the upper left tube; a steering column positioned behind the upper tube and the lower tube; a rear tube interconnected to the steering column and extending rearward; a seat post interconnected to the rear tube; and a rear triangle comprising two or more small tubes and extending rearward from the seat post, wherein the rear wheel is interconnected to the rear triangle; a first kingpin interconnected to the upper right tube and the upper left tube, wherein the first kingpin is interconnected to the first forward wheel; and a second kingpin interconnected to the upper right tube and the upper left tube, wherein the second kingpin is interconnected to the second forward wheel.

In additional or alternative embodiments, the first and second kingpins permit the first and second forward wheels to turn at different angles at the same time when the bike is turning. In additional or alternative embodiments, the first kingpin is interconnected to a first upper a-arm on an upper end of the first kingpin and the first upper a-arm is interconnected to the upper right tube, and wherein the first kingpin is interconnected to a first lower a-arm on a lower end of the first kingpin and the first lower a-arm is interconnected to the lower right tube. In some embodiments, the second kingpin is interconnected to a second upper a-arm on an upper end of the second kingpin and the second upper a-arm is interconnected to the upper left tube, and wherein the second kingpin is interconnected to a second lower a-arm on a lower end of the second kingpin and the second lower a-arm is interconnected to the lower left tube. In additional or alternative embodiments, the first upper a-arm is horizontally offset from the first lower a-arm a distance of approximately 1.0 inch, such that the first upper a-arm is positioned slightly in front of the first lower a-arm.

In some embodiments, the bike further comprises: a triangle plate; a first rod, wherein the first rod connects the first kingpin to the triangle plate; a second rod, wherein the second rod connects the second kingpin to the triangle plate; a first diamond plate, wherein the first diamond plate connects to the triangle plate; at least one tie rod; and a second diamond plate, wherein the second diamond plate connects to the first diamond plate with at least one tie rod, and wherein the second diamond plate connects to the steering post. In additional or alternative embodiments, a material for at least one of the upper right tube, the upper left tube, the lower right tube, the lower left tube, the upper tube, and the lower tube is selected from the group consisting of aluminum, titanium, steel, an alloy thereof, a composite material, and combinations thereof. In some embodiments, the bike further comprises a cargo area proximate the forward end, wherein the cargo area has an open front end and a closed rear end. In some embodiments, when the bike is turning and the first forward wheel is an inside wheel in a turn, the first forward wheel turns at a greater angle than the second forward wheel, which is an outside wheel in the turn, such that neither wheel slips in a turn. In some embodiments, the first and second forward wheels lean in a direction of a caster angle provided in a slant of the first and second kingpins.

In some embodiments, a two-tiered vehicle frame is provided comprising: a top tube; a bottom tube; a steering post, wherein the top tube extends from a front of the frame to the steering post and the bottom tube extends from the front of the frame to a location proximate the steering post; at least one rear tube; a seat post, wherein the at least one rear tube connects the steering post to the seat post; a rear triangle, wherein the rear triangle connects to the seat post and to a rear wheel; a cargo storage area located proximate the front of the frame and between a first side of the frame and a second side of the frame; and a steering system comprising: a first upper a-arm, wherein the first upper a-arm is located on a right portion of the top tube; a first bottom a-arm, wherein the first bottom a-arm is located on a right portion of the bottom tube; a second upper a-arm, wherein the second upper a-arm is located on a left portion of the top tube and opposite from the first upper a-arm; a second bottom a-arm, wherein the second bottom a-arm is located on a left portion of the bottom tube and opposite from the first bottom a-arm; a first kingpin, wherein the first kingpin is interconnected to the first upper a-arm and the first bottom a-arm; a second kingpin, wherein the second kingpin attaches between the second upper a-arm and the second bottom a-arm; a first tie rod interconnected to a bottom of the first kingpin; a second tie rod interconnected to a bottom of the second kingpin; a first steering swivel arm interconnected to the first tie rod; a second steering swivel arm interconnected to the second tie rod; a center tie rod interconnected on one end to the first steering swivel arm and interconnected on an opposite end to the second steering swivel arm; and a belt interconnected to the steering post and the second steering swivel arm.

In additional or alternative embodiments, The two-tiered vehicle frame of claim 1, wherein a material for at least one of the top tube, the bottom tube, the steering post, the at least one rear tube, the seat post, the rear triangle, the first upper a-arm, the first bottom a-arm, the second bottom a-arm, the second bottom a-arm, the first kingpin, or the second kingpin is selected from the group consisting of aluminum, titanium, steel, alloys thereof, a composite material, and combinations thereof. In additional or alternative embodiments, the two-tiered vehicle frame further comprises a kickstand system. In some embodiments, the kickstand system comprises: a kickstand interconnected to the bottom tube; a kickstand pushrod with a first end interconnected to the kickstand; and a kickstand lever interconnected on a first end to the kickstand pushrod and interconnected on a second end to the top tube. In additional or alternative embodiments, the two-tiered vehicle frame further comprises at least one support tube. In some embodiments, the two-tiered vehicle frame further comprises: a first shock interconnected on an upper end to the right portion of the top tube and interconnected on a lower end to the first bottom a-arm; and a second shock interconnected on an upper end to the left portion of the top tube and interconnected on a lower end to the second bottom a-arm.

In some embodiments, a bike is provided comprising: a forward end; a rear end; a first forward wheel proximate the forward end, wherein the first forward wheel can turn right and left; a second forward wheel proximate the forward end, wherein the second forward wheel can turn right and left; a rear wheel proximate the rear end, wherein the rear wheel is fixed and cannot turn; a frame comprising: an upper right tube proximate the forward end of the bike; an upper left tube proximate the forward end of the bike; an upper tube positioned between and interconnected to the upper right tube and the upper left tube; a lower right tube proximate the forward end of the bike; a lower left tube proximate the forward end of the bike; a lower tube positioned between and interconnected to the lower right tube and the lower left tube; a lower center tube positioned between and substantially parallel to the lower right tube and the lower left tube and interconnected to the lower tube; a kickstand mount tube interconnected on one end to the lower right tube and interconnected on an opposite end to the lower center tube; a steering column positioned behind the upper tube and the lower tube; a rear tube interconnected to the steering column and extending rearward; a seat post interconnected to the rear tube; and a rear triangle comprising two or more small tubes and extending rearward from the seat post, wherein the rear wheel is interconnected to the rear triangle; and a kickstand system comprising: a kickstand interconnected to the lower tube; a kickstand pushrod with a first end interconnected to the kickstand; a kickstand rocker interconnected to a second end of the kickstand pushrod and the kickstand mount tube; and a kickstand lever interconnected on a first end to the kickstand rocker and interconnected on a second end to the upper tube.

In additional or alternative embodiments, the bike further comprises a spring interconnected to the kickstand mount tube and the kickstand rocker. In some embodiments, the bike further comprises a first kingpin and a second king pin, wherein the first and second kingpins permit the first and second forward wheels to turn at different angles relative to a longitudinal axis of the bike at the same time when the bike is turning. In additional or alternative embodiments, the first kingpin is interconnected to a first upper a-arm on an upper end of the first kingpin and the first upper a-arm is interconnected to the upper right tube, and wherein the first kingpin is interconnected to a first lower a-arm on a lower end of the first kingpin and the first lower a-arm is interconnected to the lower right tube. In some embodiments, the second kingpin is interconnected to a second upper a-arm on an upper end of the second kingpin and the second upper a-arm is interconnected to the upper left tube, and wherein the second kingpin is interconnected to a second lower a-arm on a lower end of the second kingpin and the second lower a-arm is interconnected to the lower left tube. In some embodiments, the bike further comprises: a first tie rod interconnected to a bottom of the first kingpin; a second tie rod interconnected to a bottom of the second kingpin; a first steering swivel arm interconnected to the first tie rod; a second steering swivel arm interconnected to the second tie rod; a center tie rod interconnected on one end to the first steering swivel arm and interconnected on an opposite end to the second steering swivel arm; and a belt interconnected to the steering column and the second steering swivel arm. In some embodiments, a material for at least one of the upper right tube, the upper left tube, the lower right tube, the lower left tube, the upper tube, and the lower tube is selected from the group consisting of aluminum, titanium, steel, an alloy thereof, a composite material, and combinations thereof. In additional or alternative embodiments, the bike further comprises a cargo area proximate the forward end, wherein the cargo area has an open front end and a closed rear end. In some embodiments, when the bike is turning and the first forward wheel is an inside wheel in a turn, the first forward wheel turns at a greater angle than the second forward wheel, which is an outside wheel in the turn, such that neither wheel slips in a turn.

In some embodiments, a bike is provided comprising: a forward end; a rear end; a first forward wheel proximate the forward end, wherein the first forward wheel can turn right and left; a second forward wheel proximate the forward end, wherein the second forward wheel can turn right and left; a rear wheel proximate the rear end, wherein the rear wheel is fixed and cannot turn; a frame comprising: an upper right tube proximate the forward end of the bike; an upper left tube proximate the forward end of the bike; an upper tube positioned between and interconnected to the upper right tube and the upper left tube; a lower right tube proximate the forward end of the bike; a lower left tube proximate the forward end of the bike; a lower tube positioned between and interconnected to the lower right tube and the lower left tube; a lower center tube positioned between and substantially parallel to the lower right tube and the lower left tube and interconnected to the lower tube; a steering column positioned behind the upper tube and the lower tube; a rear tube interconnected to the steering column and extending rearward; a seat post interconnected to the rear tube; and a rear triangle comprising two or more small tubes and extending rearward from the seat post, wherein the rear wheel is interconnected to the rear triangle; and a steering system comprising: a first upper a-arm, wherein the first upper a-arm is located on the upper right tube; a first bottom a-arm, wherein the first bottom a-arm is located on the lower right tube; a second upper a-arm, wherein the second upper a-arm is located on the upper left tube; a second bottom a-arm, wherein the second bottom a-arm is located on the lower left tube; a first kingpin, wherein the first kingpin is interconnected to the first upper a-arm and the first bottom a-arm; a second kingpin, wherein the second kingpin attaches between the second upper a-arm and the second bottom a-arm; a first tie rod interconnected to a bottom of the first kingpin; a second tie rod interconnected to a bottom of the second kingpin; a first steering swivel arm interconnected to the first tie rod; a second steering swivel arm interconnected to the second tie rod; a center tie rod interconnected on one end to the first steering swivel arm and interconnected on an opposite end to the second steering swivel arm; and a belt interconnected to the steering column and the second steering swivel arm.

In additional or alternative embodiments, the bike further comprises a cargo area proximate the forward end, wherein the cargo area has an open front end and a closed rear end. In some embodiments, the bike further comprises a kickstand system comprising: a kickstand interconnected to the lower tube; a kickstand pushrod with a first end interconnected to the kickstand; a kickstand rocker interconnected to a second end of the kickstand pushrod and a kickstand mount tube; and a kickstand lever interconnected on a first end to the kickstand rocker and interconnected on a second end to the upper tube. In some embodiments, the bike further comprises a spring interconnected to the kickstand mount tube and the kickstand rocker. In additional or alternative embodiments, the bike further comprises a handle interconnected to the second end of the kickstand lever.

An aspect of the invention is a three-wheeled bike that includes a belt steering system. The bike includes a frame, three wheels, and a steering system. At least one wheel, in some embodiments two wheels, is connected to the steering system with a belt, that is interconnected to a steering a steering column of the steering system.

In one embodiment, a method of assembly process is provided comprising: milling steel; placing the steel in a jig for a front of a bike; performing tack attachments; completing the attachment; removing the bike from the jig; milling and forming steel into a rear triangle for the bike; placing the rear triangle in the jig; performing tack attachments on the rear triangle; incorporating dropouts; completing the attachments on the rear triangle; removing the rear triangle from the jig; placing the front of the bike in the jig; placing the back of the bike in a second jig; tack attaching a top tube and a bottom tube to the front and back of the bike; remove the bike from the jigs; and attaching the center structural tube to the bike. The order depicted in these steps can be altered without deviating from the invention. For example, the steps can be in reverse, or a section of the bike can be manufactured then joined to the remaining portions of the bike. The portions can be attached by welding, gluing, brazing, soldering, and other fusion processes that create a sufficient amount of strength to permanently join the materials. In some embodiments, the attachment method can be welding. In some embodiments, tack attaching steps may not be necessary.

In various embodiments, a method of assembling a cargo bike frame is provided comprising: placing steel tubes for a front of the bike onto a cutting bed of a laser cutter; cutting both ends of each steel tube, wherein the cut is a straight cut or a miter cut; bending each tube into a desired shape to form a top tube and a bottom tube; placing the shaped tubes onto a jig; placing internal sleeves on selected butt joints; performing tack attachments on joints & joined parts; completing the attachments; removing the bike from the jig; milling and forming steel into a rear triangle; placing the rear triangle in the jig; performing tack attachments on joints & joined parts; incorporating dropouts; completing the attachments; removing the rear triangle from the jig; placing the front of the bike and a back of the bike into the jig; tack attaching the top tube to the front and back of the bike; tack attaching the bottom tube to the front and back of the bike; removing the bike from the jig; attaching the center structural tube to the bike. The order depicted in these steps can be altered without deviating from the invention. For example, the steps can be in reverse, or a section of the bike can be manufactured then joined to the remaining portions of the bike. The attachments can be formed by welding, gluing, brazing, soldering, and other fusion processes that create a sufficient amount of strength to permanently join the materials. In some embodiments, the attachment method can be welding. In some embodiments, tack attaching steps may not be necessary.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about”.

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

### BRIEF DESCRIPTION OF THE DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the Detailed Description of the drawings given below, serve to explain the principles of the invention.

FIG. 1 is side view of a frame according to embodiments of the present invention;

FIG. 2 illustrates a top view for a three-wheeled vehicle illustrating how the steering axes meet at one point in an embodiment of the invention;

FIG. 3 illustrates an axonometric view of the suspension with top and bottom a-arms and kingpin in an embodiment of the invention;

FIG. 4 illustrates a bottom view of a vehicle looking upward at steering components in an embodiment of the invention;

FIG. 5 illustrates a front view of a vehicle in an embodiment of the invention;

FIG. 6 illustrates a side view of suspension to illustrate camber;

FIG. 7 illustrates an inside rear view of the kingpin;

FIG. 8 illustrates the inside front view of the kingpin;

FIG. 9 illustrates a bike with cargo storage according to embodiments of the invention;

FIG. 10 is a perspective view of a frame according to embodiments of the present invention;

FIG. 11 is a perspective view of a frame of the cargo area according to embodiments of the present invention;

FIG. 12 illustrates an embodiment of the invention with the bike and the cargo storage;

FIG. 13 is a side perspective view of a bike frame and cargo storage according to embodiments of the present invention;

FIG. 14 is a top side perspective view of the bike frame of FIG. 13 without the cargo storage;

FIG. 15 is a front perspective view of the bike frame of FIG. 14;

FIG. 16 is a bottom view of the cargo frame of FIG. 14;

FIG. 17 is a front perspective view of a cargo frame according to embodiments of the present invention;

FIG. 18 is a top plan view of the cargo frame of FIG. 17;

FIG. 18A is a cross sectional view of the kickstand mount tube taken at line A-A of FIG. 18;

FIG. 18B is a front elevation view of the cargo frame of FIG. 17

FIG. 18C is a left side elevation view of the cargo frame of FIG. 17;

FIG. 19 illustrates a kickstand pushrod according to embodiments of the present invention;

FIG. 20 illustrates a kickstand upper portion according to embodiments of the present invention;

FIG. 21 illustrates a kickstand lower portion according to embodiments of the present invention;

FIG. 22 illustrates a kickstand lever according to embodiments of the present invention;

FIG. 23 illustrates a kickstand rocker to embodiments of the present invention;

FIG. 24A is a perspective view of an upper a-arm according to embodiments of the present invention;

FIG. 24B is a top plan view of the upper a-arm of FIG. 24A;

FIG. 25A is a perspective view of a lower a-arm according to embodiments of the present invention;

FIG. 25B is a cross-sectional view of the lower a-arm of FIG. 25A;

FIG. 26 is a perspective inside view of the first end of the kickstand pushrod, the left lower a-arm, and the steering belt according to embodiments of the present invention; and

FIG. 27 is a perspective inside view of the second end of the kickstand pushrod, kickstand, the left lower a-arm, and left shock according to embodiments of the present invention.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the inventions described herein are capable of other embodiments and of being practiced or of being carried out in various ways. It is to be understood that the phraseology and terminology used herein is for the purpose of description and should not be regarded as limiting.

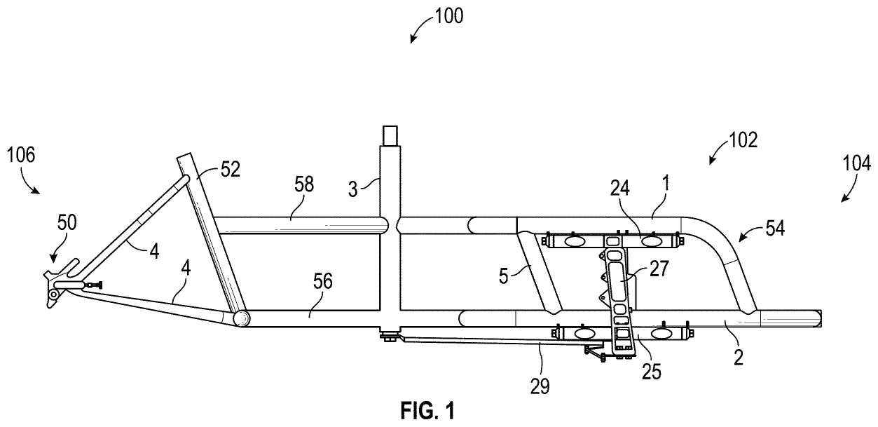

FIG. 1 is a side view of the bike frame 100 with different diameter tubing. The front 104 of the frame 100 is shown on the right and the rear 106 of the frame 100 is shown on the left. In the embodiment shown, the bike frame 100 comprises large tubing 1, 2, 5, 52, 56, 58 and small tubing 4. The large tubing can all be the same size or may vary in diameter. For example, some of the large tubing 1, 2, 5, 52, 56, 58 can be one diameter while the other large tubing 1, 2, 5, 52, 56, 58 can be another diameter. In some embodiments, the steering column tube 3 can be the same diameter as the large diameter tubing 1, 2, 5, 52, 56, 58; while in other embodiments, the steering column tube 3 can be a different diameter. In one embodiment, the diameter of the large tubing 1, 2, 5, 52, 56, 58 can be between about 1.00 inch and about 2.00 inches. In some embodiments, at least some of the large tubing 1, 2, 5, 52, 56, 58 can have a diameter that is about 1.10 inches, about 1.20 inches, about 1.30 inches, about 1.40 inches, about 1.50 inches, about 1.60 inches, about 1.70 inches, about 1.80 inches, or about 1.90 inches. In a preferred embodiment, at least some of the large tubing 1, 2, 5, 52, 56, 58 can have a diameter that is about 1.50 inches. In one embodiment, the thickness of the large diameter tubing 1, 2, 5, 52, 56, 58 is between about 0.10 inches and about 0.50 inches. In a preferred embodiment, the thickness of the large diameter tubing 1, 2, 5, 52, 56, 58 can be about 0.35 inches. In some embodiments, the thickness of the large diameter tubing 1, 2, 5, 52, 56, 58 can be about 0.15 inches, about 0.20 inches, about 0.25 inches, about 0.30 inches, about 0.40 inches, or about 0.45 inches. In one embodiment, the steering tube 3 has a diameter between about 1.50 inches and about 2.00 inches. In a preferred embodiment, the steering tube 3 has a diameter of about 1.73 inches. In one embodiment, the thickness of the steering tube 3 is between about 0.10 inches and about 0.5 inches. In a preferred embodiment, the thickness of the steering tube 3 is about 0.35 inches. The terms “steering column tube,” “steering column,” and “steering tube” can be used interchangeably herein for the column/tube to which the steering wheel or handle is interconnected and which is identified as item 3 in the figures.

Some of the large diameter tubing 1, 2, 5 supports the cargo area 54 and forms the cargo frame 102. The top tubing 1 (also called the “upper tube,” “top tube,” and “upper tubing” herein) and bottom tubing 2 of the cargo frame 102 are interconnected (for example, welded in one embodiment) on one end to the steering column tube 3. On the front end of the bike frame, the top tubing 1 curves downward and interconnects to the bottom tubing 2. The tubing 56, 58 behind the steering column 3 terminate and are interconnected (for example, welded in one embodiment) to the seat post 52. In the embodiment shown, the tubing 56, 58 behind the steering column 3 are large diameter tubing. Both tubing 56, 58 can be the same diameter or can be different diameters. For example, the lower tubing 56 can have a larger diameter than the upper tubing 58.

The smaller diameter tubing 4 (also called “armatures” herein) is interconnected (for example, welded in one embodiment) to the seat post 52 to form the rear triangle. There are multiple tubes 4 on the rear triangle, but only two are visible in this view. Each tube 4 can be the same diameter and thickness, or different diameters and thicknesses. The diameter, length, and spacing of the rear triangle tubes 4 can be sized to receive a standard bike tire. In some embodiments, a 27.5 inch diameter bike tire can be adapted to be received by the rear triangle. The rear triangle tubes 4 can terminate in an adjustable dropout 50 for receiving a bike tire. Any sized bike tire (i.e., diameter and thickness) could be used in various embodiments. The bike tire can be a road tire, a mountain tire, a sand tire or a snow tire, for example.

In some embodiments, a frame-mounted electric assist motor can be accommodated on the bike frame 100, for example at the bottom bracket area, which is located at the bottom end of the seat tube 52 where it meets the bottom tube 56 and both lower armatures 4 of the lower rear triangle.

In some embodiments, the seat tubing 52 can be the industrial standard size for seat tubing to allow for various seats to be inserted into the seat tube 52. A seat pin can be used, which can be based on industrial standards and which allows quick adjustments of the seat height and angle of the seat relative to the frame.

The material for the bike frame or any component of the bike can be metal, by way of example, aluminum, titanium, steel, alloys thereof, or combinations thereof, or a composite material, for example, a carbon composite material. Materials for some components, for example the kingpin, the diamond plate, and the triangle plate, can be chosen, for example, based on the likelihood of damage caused by oxidation. For example, components that are likely to be scratched and exposed to the elements can be made from materials such as stainless steel to provide added resistance to oxidation. Additionally, coatings can be added (or treatments performed) to the components to resist oxidation. Other components that are less likely to be exposed to the elements and/or are less susceptible to oxidation can be made of materials that are susceptible to oxidation because the likelihood of such is low. For example, the shock cleats or a-arm cleat can be made from a plain steel instead of a stainless steel. Some components can be made of aluminum, for example suspension components. However, one skilled in the art would understand that the suspension parts can be made from other materials without deviating from the invention. One skilled in the art would also understand that the method used to attach the parts to each other will depend upon the material being used. For example, an epoxy or glue can be used to join composite materials or metal and composite materials, where a weld, solder, or braze can be used to join metal materials. Mechanical attachments can also be used, for example, screws or bolts, etc.

As an added measure of strength between the top tube 1 and bottom tube 2, an angle tube 5 can be interconnected (in some embodiments, it is welded) to the top tube 1 and the bottom tube 2. The angle between the angle support tube 5 and the bottom tube 2 can be between about 50° and about 130°. In some embodiments, the angle between the angle support tube 5 and the bottom tube 2 can be about 55°, about 60°, about 65°, about 70°, about 75°, about 80°, about 85°, about 90°, about 95°, about 100°, about 105°, about 110°, about 115°, about 120°, or about 125°. In one embodiment, there are at least two angled support tubes 5 on each side of the bike frame 100. In another embodiment, there is only one angled support tube 5 on each side of the bike frame 100. In some embodiments, no angled support tube 5 are used.

In some embodiments, positioned on a side of the cargo frame 102 is an upper a-arm 24 and a lower a-arm 25 interconnected to each other via a kingpin 27. The upper a-arm 24 is positioned proximate the upper tube 1 and the lower a-arm 25 is positioned proximate the lower tube 2. The steering tie rods 29 are also visible in FIG. 1. In some embodiments, the upper a-arm 24 is interconnected to the underside of the upper tube 1 of the cargo frame 102 and the lower a-arm 25 is interconnected to the underside of the bottom tube 2 of the cargo frame 102.

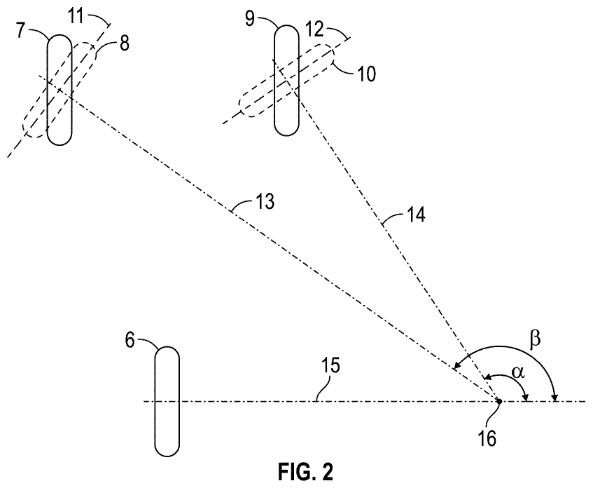

FIG. 2 illustrates a top view diagram of a three-wheeled vehicle according to an embodiment of the present invention. The two front wheels are illustrated in a straight position 7, 9 and a turned position 8, 10. The rear wheel 6 remains stationary or pointing straight (i.e., parallel to the straight position 7, 9 of the front two wheels). The dashed lines 13, 14, 15 meet at one central point 16. FIG. 2 also illustrates the Ackermann steering diagram because the front wheels in the straight position 7, 9 become wheel positions 8 and 10 when turning. While the turned front wheel positions 8, 10 are illustrated turning to the right, one skilled in the art would understand that the wheels could be turned to the left without deviating from the invention.

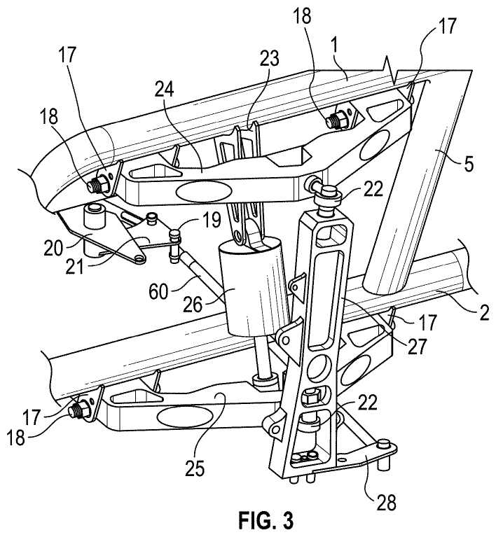

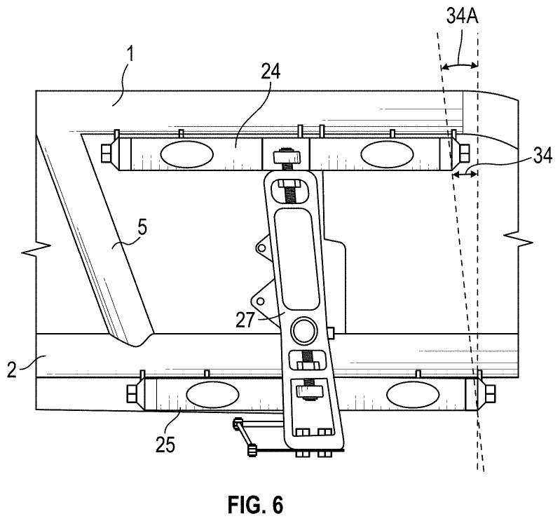

As the vehicle is moved into a turned position, the center of wheel positions 8 and 10 are represented as dashed centerlines 11 and 12 and are perpendicular to dashed lines 13 and 14, which intersect at the point 16. Once the dashed lines 13 and 14 intersect at center point 16, the wheels/tires will lean in the direction of a caster angle 34A provided in the slant of the kingpin 27 (illustrated in FIG. 6). When this occurs, a one-inch offset 34 between the upper a-arm 24 (illustrated in FIGS. 3 and 6) and lower a-arm 25 (illustrated in FIGS. 3 and 6) comes into play, keeping the wheel firmly planted and the vehicle turning in its intended direction. The rear wheel 6 will lean into the direction of the turn and the shock 26 (illustrated in FIG. 3) can dampen the reactive forces by transferring some of the forces into the frame top tube 1 (illustrated in FIGS. 1 and 3).

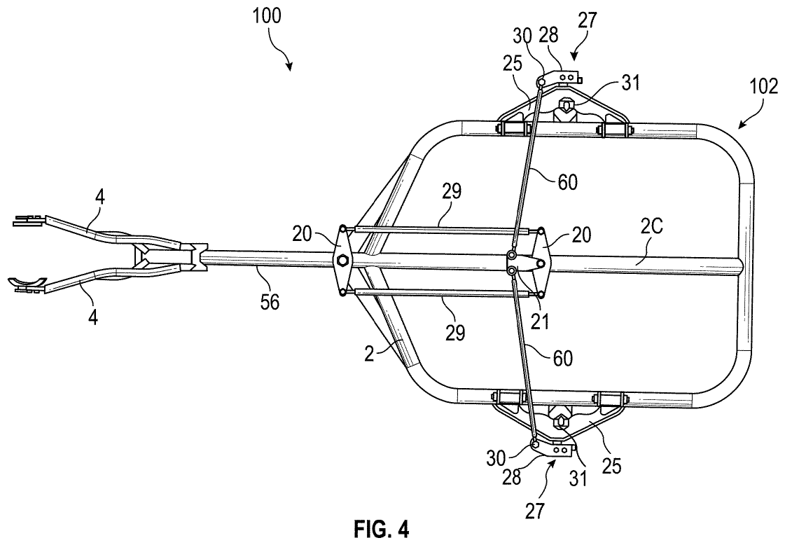

FIG. 3 illustrates the axonometric relationship between the shock 26, a-arms 24, 25, kingpin 27, and steering tie rods 29 (shown in FIG. 4 and interconnected to fasteners 19). The a-arm connections can include a-arm cleats 17 and fasteners (e.g., bolts or screws) 18 and the a-arm cleats are interconnected (for example, welded or bolted) to the underside of top tube 1 of the frame and to the underside of the bottom tube 2. The lower a-arm 25 is connected to the bottom tube 2 with an a-arm cleat 17 and a fastener 18. The upper a-arm 24 is connected to the upper tube 1 with an a-arm cleat 17 and a fastener 18.

In some embodiments, the top tube 1 can have a thicker sidewall than the bottom tube 2 because the top tube 1 must be capable of resisting bending forces from the shock 26, as these forces are transferred to the top tube 1. The shock cleats 23, which can be waterj et cut, are interconnected or welded to the underside of the top frame tube 1 The shock cleats 23 can be interconnected or welded directly to the bottom of the top tube 1. The shock cleats 23 are also centered between the bolted a-arm connections 18, or centrally located (within about plus or minus 5% from the center point) relative to the upper a-arm 24. The bottom shock connection is centrally located (within about plus or minus 5% from the center point) relative to the center of the bottom a-arm 25 and is fastened with, by way of example, a bolt and lock nut. During rotational movement, the shock 26 moves with the lower a-arm 25 to dampen vibrational forces, hence providing a more comfortable and controlled ride for the operator.

The multidirectional super-swivel ball joints 22, are bolted to the top and bottom of the kingpin 27. The super-swivel ball joints 22 allow the wheel/tire to turn in the fore and aft direction, which allow turning from right to left.

Turning the handle bars mounted at the upper end of the steering tube 3 (illustrated in FIG. 1) controls steering. The diamond plate 20 and triangular plate 21 (which can be made of a metal such as stainless steel, aluminum, titanium, alloys thereof, or the like) underneath the vehicle are connected or bolted with fasteners 19 to steering rods 29 (in FIG. 4) coming from the steering tube 3 (illustrated in FIG. 1), as well as rods 60 that attach the triangular plate 21 to the kingpin 27. One skilled in the art would understand that the general shape of the diamond plate 20 and triangular plate 21 can vary without deviating from the invention. The kingpin connection plate 28 (which can be made from a metal such as stainless steel, aluminum, titanium, alloys thereof, or the like) is attached to the bottom of the kingpin 27. The attachment of the kingpin 27, kingpin connection plate 28, rods 60, triangle plate 21, diamond plate 20, and steering rods 29 allows the vehicle to be steered.

FIG. 4 is a bottom view of the bike frame 100 and illustrates the relationship of the steering components and the kingpin 27 according to one embodiment of the present invention. Two diamond plates 20 interconnect to the bottom of the center bottom tube 2C and one diamond plate 20 (the rear plate shown on the left of FIG. 4) interconnects to the bottom of the steering column 3 (illustrated in FIG. 1). The diamond plates 20 can be the same size or the sizes can vary. The two diamond plates interact with each other and are interconnected to each other via two steering rods 29. Two rods 60 interconnect to the triangle plate 21 and are positioned between the kingpins 27 and in the middle (about +/−10%) of the cargo frame 102. The triangular plate 21 is bolted or interconnected to and works in conjunction with the diamond plate 20 under the approximate center of the cargo from 102. A shock 26 (shown in FIG. 3) is bolted or otherwise interconnected to the bottom a-arm 25 at interconnection point 31. The rods 60 (which can be solid or hollow) are then bolted or interconnected with a fastener 30 to the kingpin-connection plate 28, located at the bottom of the kingpin 27. This configuration allows the vehicle to turn right or left. The top tubing 1 is not visible in FIG. 4 because the top tubing 1 and the bottom tubing 2 are in the same vertical plane. It is possible to offset the bottom tube 2 and the top tube 1 so that the bottom tube 2 is slightly inward (i.e., between about 0.125 inches and about 0.75 inches difference between the centerline of the top tube 1 and the center line of the bottom tube 2, or about 0.20 inches, about 0.25 inches, about 0.30 inches, about 0.35 inches, about 0.40 inches, about 0.45 inches, about 0.50 inches, about 0.55 inches, about 0.60 inches, about 0.65 inches, or about 0.70 inches). Offsetting the top tube 1 and bottom tube 2 will result in a smaller turning radius for the bike.

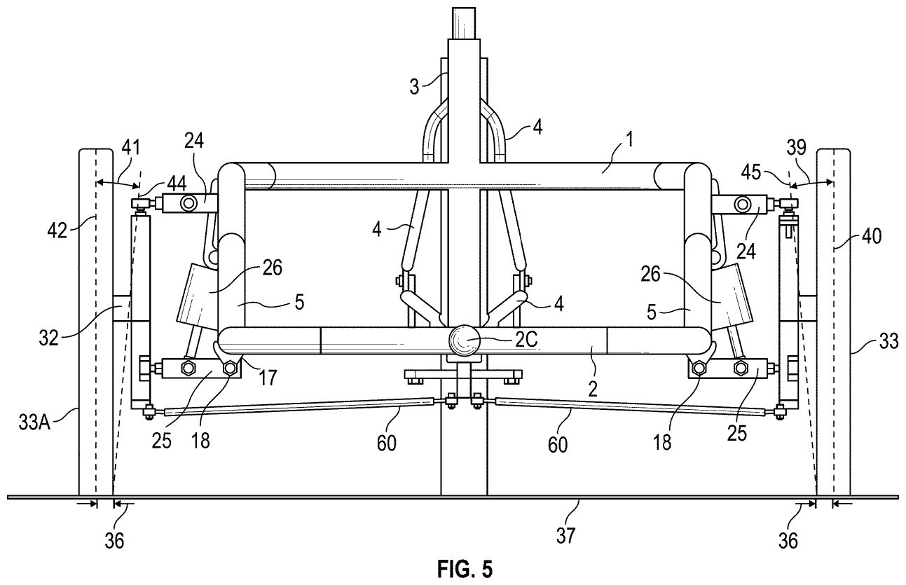

FIG. 5 illustrates a front view of the vehicle according to embodiments of the invention. Wheel movement occurs when the right wheel 33A at the wheel centerline 42 engages with the ground or surface 37 (i.e., when the axel 32 is approximately perpendicular with the wheel 33A). Three points are made to operate in a triangular sequence and intersect: axis 44, true wheel center 42, and the ground plane 37. Movement can also occur when the wheel 33A is at an angle 41 so that the wheel centerline 42 approaches axis 44 and contacts the surface 37 near the edge of the wheel 33A. Conversely, on the left side of the vehicle, angle 39, center wheel position or wheel centerline 40, and the ground plane 37 all intersect and work to balance the right side of the vehicle. Ideally the angles 39, 41 of each wheel are the same. When all conditions are met on both sides of the vehicle, then the camber is achieved. In one embodiment, angles 39 and 41 are between about 1° and about 45°. In a preferred embodiment, angles 39 and 41 are between about 5° and about 35°. In a more preferred embodiment, angles 39 and 41 are between about 10° and about 25°. In some embodiments, angle 39 and 41 are about 5°, about 10°, about 15°, about 20°, about 25°, about 30°, about 35°, or about 40°. When angles 39, 41 are at about 0°, the movement of the bike would be straight and not turning.

The shock 26 is mounted to the lower a-arm 25 with the connector 18. In one embodiment, the camber offset 36 is between about 0.75 inches and about 1.5 inches. In some embodiments, the camber offset 36 is about 0.8 inch, about 0.85 inch, about 0.9 inch, about 0.95 inch, about 1.05 inch, about 1.1 inch, about 1.15 inch, about 1.2 inch, 1.25 inch, about 1.3 inch, about 1.35 inch, about 1.4 inch, or about 1.45 inch. In a preferred embodiment, the camber offset 36 is about a one-inch offset. The camber offset 36 is dictated by both the movement of the swivel joint 22 (see FIG. 3) and the a-arms 25, 24 during vehicle travel over uneven surfaces and throughout the duration of a turn.

FIG. 6 is a side view of the suspension used to better illustrate the caster offset 34. The caster offset 34 is between about 0.75 inches and about 1.5 inches, in some embodiments. In some embodiments, the caster offset 34 is about 0.8 inch, about 0.85 inch, about 0.9 inch, about 0.95 inch, about 1.05 inch, about 1.1 inch, about 1.15 inch, about 1.2 inch, 1.25 inch, about 1.3 inch, about 1.35 inch, about 1.4 inch, or about 1.45 inch. In a preferred embodiment, the caster offset 34 is about 1 inch. FIG. 6 also illustrates an embodiment where the camber angle is positive. In other words, the top of the kingpin pivot point is pulled back from the bottom of the kingpin pivot point. The positive camber angle 34A increases stability of the bike compared to negative camber angles, which can be advantageous, especially at high speeds and can increase tire lean while cornering. The caster offset 34 is due to the location the kingpin 27 interconnected to the top tube 1 relative to the bottom tube 2.

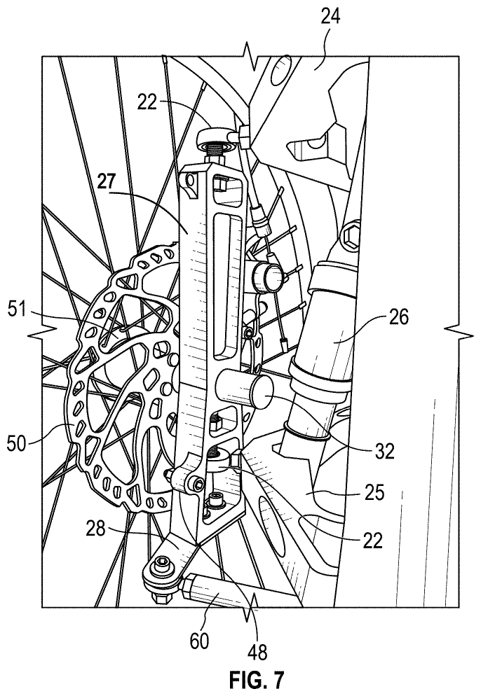

FIG. 7 illustrates a rear inside view of embodiments of the kingpin 27 and illustrates the many functions of this component. The connection plate 28 is located below the kingpin 27 and at the lower end of the kingpin 27. A wheel stop 48 prevents the tire/wheel from turning into the frame. The wheel stop 48 can be centrally located and/or near the lower super-swivel ball joint 22. Above the lower super-swivel ball joint 22 is the axle 32 in which the hub 51 and brake 50 are positioned. Thus, the axle 32 interconnects the kingpin 27 to the brake 50. Finally, at the top of FIG. 7 is the upper super-swivel ball joint 22, which was also illustrated in FIG. 3.

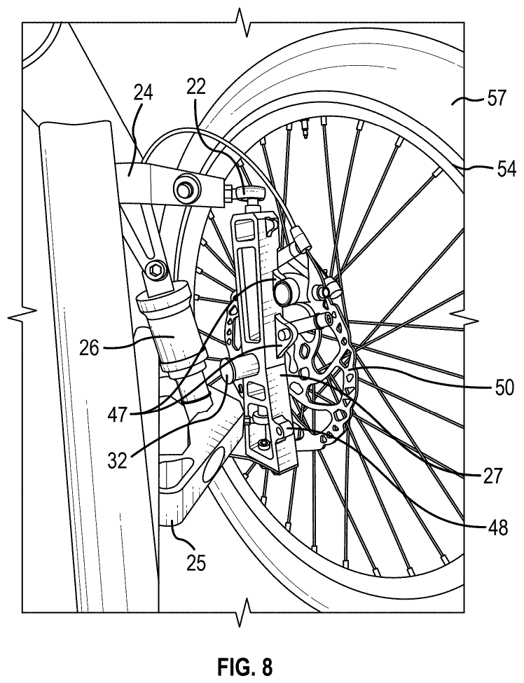

FIG. 8 is an inside front view of the kingpin 27 and illustrates the brake mount 47. Note that the bottom mount on the outside edge of the kingpin 27, across from the a-arm 25, can be left unused because the kingpin design is universal. Meaning a single design of the kingpin 27 can be used on both sides of the bike by flipping the component in the opposite direction. The wheel stop 48 can be located between the kingpin 27 and the wheel 54. The brake mounts 47 can be located on the kingpin 27. The wheel 54 and tire 57 are shown in FIG. 8.

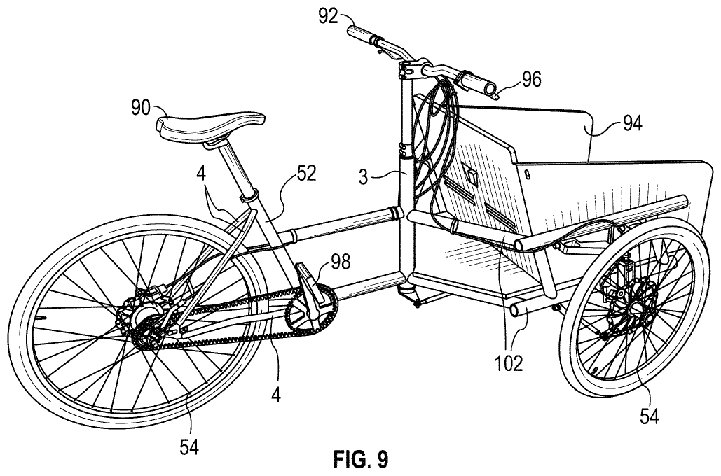

FIG. 9 illustrates one embodiment of the bike with a cargo storage 94 attached to the front of the bike, and specifically attached to the cargo frame 102. The bike further includes a seat 90, that can be any suitable seat, and is positioned in the seat tube 52. The bike also includes handle bars 92, which can be straight bars or shaped handle bars, and which are interconnected to the steering column 3. In some embodiments, the handle bars 92 can be wider than a standard handle bar to allow for more control of the bike. FIG. 9 shows the brakes of the bike being controlled by brake devices 96 on the handle bar 92, though one skilled in the art would understand that the brakes can be controlled by the pedals 98 without deviating from the invention. The cargo storage 94 can be any suitable shape to fit the cargo space or cargo frame 102 of the bike. The cargo storage 94 can be made of wood, metal, composite, plastic, polycarbonate, combinations thereof, or any other material known in the art. The cargo storage 94 can be any size to fit into the area provided by the cargo frame 102 of the bike. In some embodiments, more than one cargo storage unit can be utilized. Furthermore, the cargo storage unit 94 can be removable, which can allow for easy storage, transport, and shipping of the bike. The cargo storage 94 can be adapted to provide seating for one or more passengers. The cargo storage 94 can be enclosed or open. The wheels 54 of the bike can be the same size or can be different sizes, and can be standard sized or custom made.

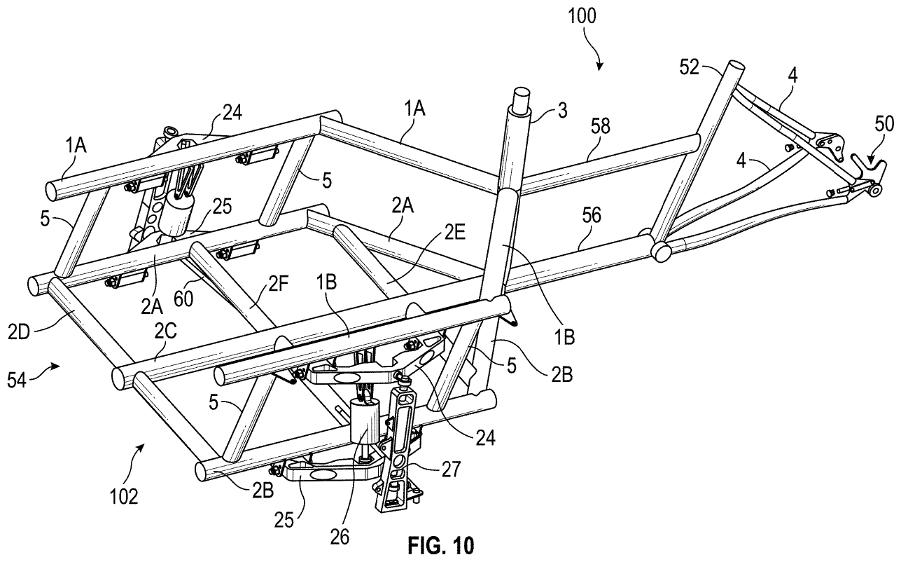

FIG. 10 is a perspective view of the frame 100 of the bike according to embodiments of the present invention. The cargo area 54 is in the front of the bike and is formed by the cargo frame 102. The frame 100 can be adapted to be collapsible, reducing the frame's overall width and volume so that the bike can be easier to store, transport, or ship. The frame includes right upper tubes 1A, left upper tubes 1B, right lower tubes 2A, left lower tubes 2B, a center lower tube 2C, and one or more perpendicular tubes 2D, 2E, 2F positioned substantially perpendicular to and through the center lower tube 2C. The lower left and right tubes 2B, 2A can be substantially parallel to center lower tube 2C. The frame also includes angled support tubes 5, a steering column tube 3, and tubing 56, 58 behind the steering column tube 3. Behind the tubes 56, 58 is the seat tube 52, and behind the seat tube 52 are the rear triangle tubes 4, which terminate in an adjustable dropout 50 for receiving a bike tire.

FIG. 11 is a perspective view of a cargo area frame 102 according to embodiments of the present invention. Here, the frame 102 tubing is bent to interconnect the top tubes 1A, 1B to the bottom tubes 2A, 2B via front angled tube portions 68. The cargo area 54 is in the front of the frame 102. The frame 102 includes a right upper tube 1A, a left upper tube 1B, an upper rear tube 1, a right lower tube 2A, a left lower tube 2B, a center lower tube 2C, a lower front tube 2D, a lower rear tube 2E, and angled support tubes 5 positioned between the upper and lower tubes 1A, 1B, 2A, 2B.

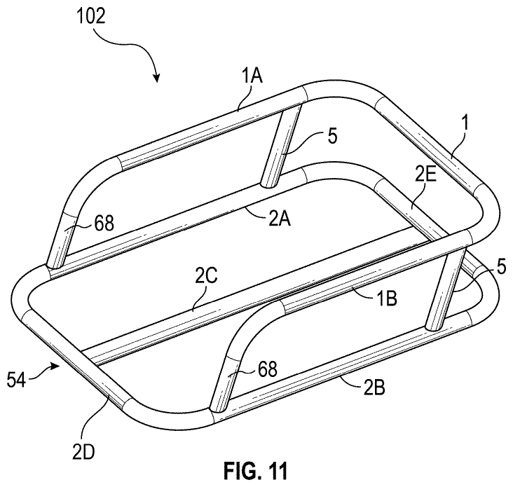

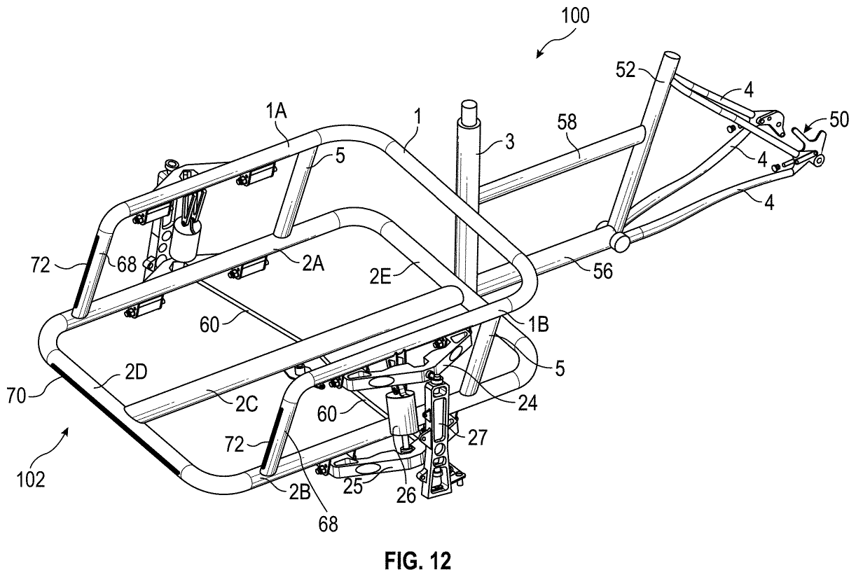

FIG. 12 is a perspective view of the bike frame 100 and front cargo frame 102 according to an embodiment of the invention. The frame 100 of FIG. 12 includes elements that are similar to the elements described in FIG. 10, but the configuration of the cargo frame 102 in FIG. 12 is slightly different in that it incorporates the cargo area 54 as described in FIG. 11. Thus, the frame tubing is bent to interconnect the top tubes 1A, 1B to the bottom tubes 2A, 2B via front angled tube portions 68. Bending the cargo frame 102 as illustrated in FIG. 11 decreases the number of attachments required during manufacturing, which can result in fewer failure points and reduction of production costs. The frame 100 can be adapted to provide collapsibility, reducing the overall width and volume so that the bike can be easier to store, transport, or ship. The frame 100 also includes angled support tubes 5, a steering column tube 3, and tubing 56, 58 behind the steering column tube 3. Behind the tubes 56, 58 is the seat tube 52, and behind the seat tube 52 are the rear triangle tubes 4, which terminate in an adjustable dropout 50 for receiving a bike tire. In some embodiments, the front of the frame 100 has one or more bumpers 70, 72 for upright storage and to protect against damage in accidents. One bumper 70 may be on the lower front tube 2D and each front angled tube 68 can have a bumper 72. The bumpers 70, 72 can be rubber or any other deformable, sturdy material.

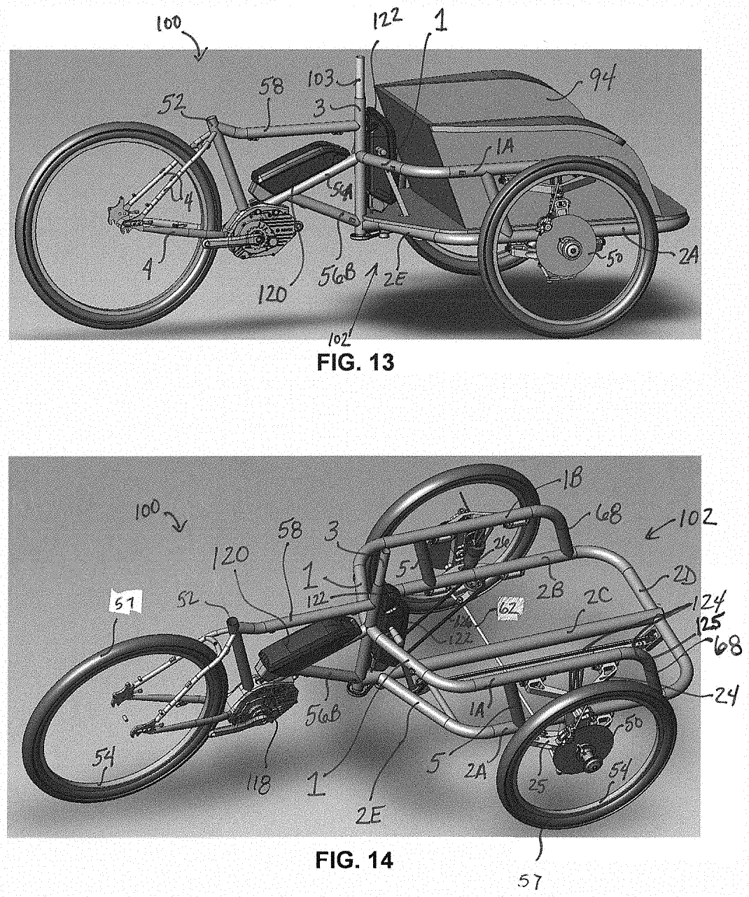

FIGS. 13-18C show another embodiment of the bike frame 100 and cargo frame 102. The cargo frame 102 of FIGS. 13-18C is similar in some ways to the cargo frame of FIGS. 4, 5, 11, and 12 and is similar in other ways to the cargo frame of FIGS. 1, 9, and 10. For example, the cargo frame 102 of FIGS. 13-18C has rounded portions and comprises tubing with bent corners. Additionally, the cargo frame 102 has angled upper rear tubes 1, 1C and lower rear tubes 2E, 2G proximate the steering column 3.

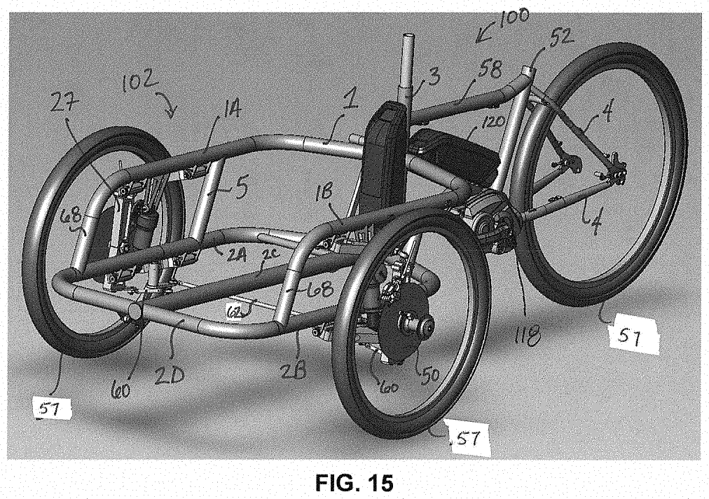

FIGS. 13 and 14 are right perspective views of an embodiment of the bike frame 100 with and without the cargo storage 94. FIG. 15 is a front perspective view of the bike frame 100. The bike frame 100 is comprised of tubing, including a cargo frame 102 comprised of tubing. For example, the cargo frame 102 is positioned proximate the front of the bike and include an upper right tube 1A, a lower right tube 2A, an upper left tube 1B, a lower left tube 2B, a lower front tube 2D, a center lower tube 2C positioned substantially parallel to the lower right and left tubes 2A, 2B, an upper rear tube 1, and a lower rear tube 2E. The upper rear tube 1 and lower rear tube 2E are interconnected to the steering column 3. A handle bar post 103 extends outward and upward from the steering column 3. An upper tube 58 interconnects the steering tube 3 to the seat tube 52. Additionally, a first lower tube 56A and a second lower tube 56B also interconnect the steering tube 3 to the seat tube 52, but the second lower tube 56B is interconnected on one end to the steering tube 3 and interconnected on a second end to the first lower tube 56A. An e-assist motor 118 is positioned on and/or proximate to the bike's gears and pedals. A first battery 120 is positioned on and/or interconnected to the first lower tube 56A. The first battery 120 can power the e-assist motor, which provides power to the rear wheel, and/or bike lights. In some embodiments, the first battery 120 is positioned in different locations on the bike. Extending rearward from the seat tube 52 are the rear triangle tubes 4, which interconnect to the rear wheel 54. As with the other embodiments, the rear wheel and two front wheels can be any practical diameter size and the tires 57 can be any width or thickness (e.g., thin/skinny road tires or thick/wide snow, mountain, or sand tires). The two front wheels/tires are interconnected to the cargo frame 102 via the brake 50. The short tie rods 60 (which can be solid or hollow) are interconnected to a kingpin connection plate 28, located at the bottom or lower end of the kingpin 27. The kingpin 27 is interconnected to an upper a-arm 24, which is interconnected to the upper tube 1A, 1B, and interconnected to a lower a-arm 25, which is interconnected to the lower tube 2A, 2B.

The bike has a second battery 122 interconnected to the steering column 3 in some embodiments. In other embodiments, the second battery 122 is positioned in a different location on the bike. The second battery 122 is provided to extend the range of the bike using the e-assist motor. The second battery 122 can also power the lights or any other components needing power.

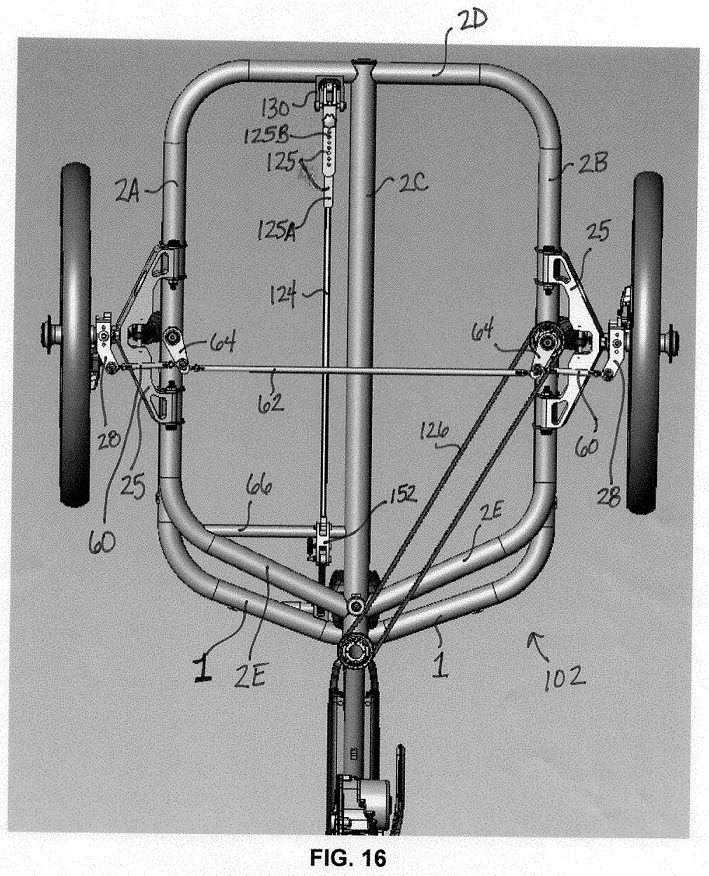

The frame 100 also has a kickstand pushrod 124, a kickstand 125, and a steering belt 126, which are described further in connection with FIG. 16. The bike also has a tie rod or pushrod tube 62 extending substantially perpendicular to the center lower tube 2C.

FIG. 16 is a bottom view of the cargo frame 102. Note that due to the orientation of the bike in FIG. 16, the right side of the cargo frame 102 is shown on the left side of FIG. 16 and the left side of the cargo frame 102 is shown on the right side of FIG. 16. All of the upper tubes are not directly in line (vertically) with the lower tubes since portions of the upper tubes can be seen in this view. For example, the lower right tube 2A, the lower left tube 2B, the lower front tube 2D, the center lower tube 2C, the upper rear tube 1, and a lower rear tube 2E can be seen in this view. Thus, the upper rear tube 1 is positioned slightly rear of the lower rear tube 2E. The upper rear tube 1 is interconnected to the steering column 3 and the lower rear tube 2E is interconnected to the center lower tube 2C just forward of the steering column 3.

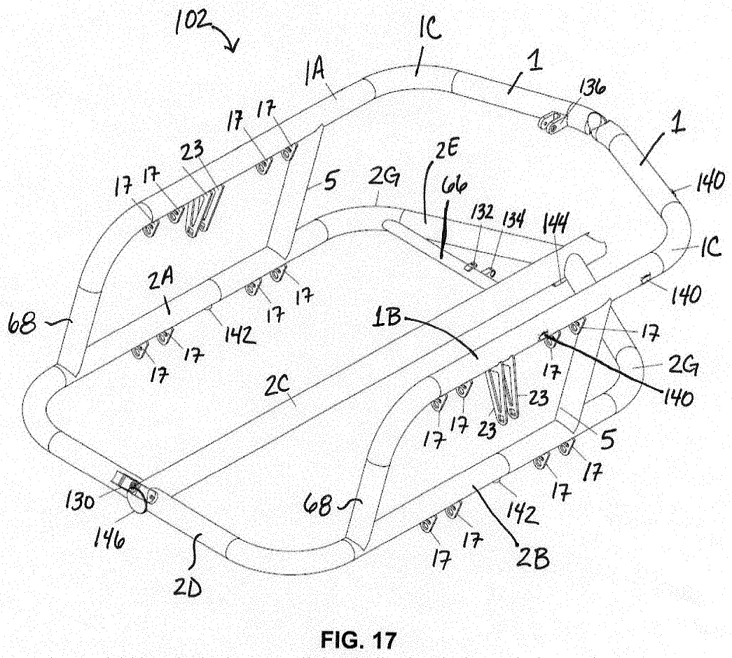

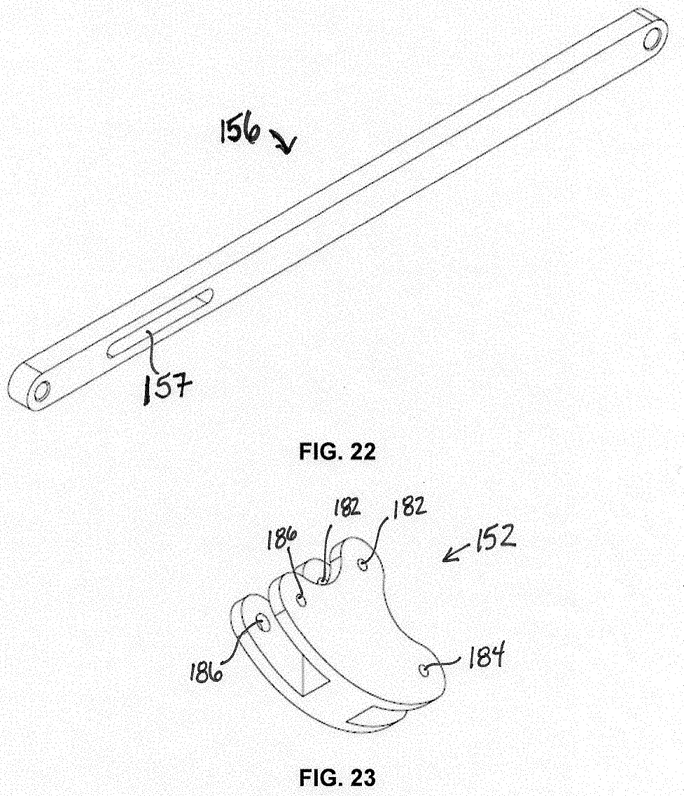

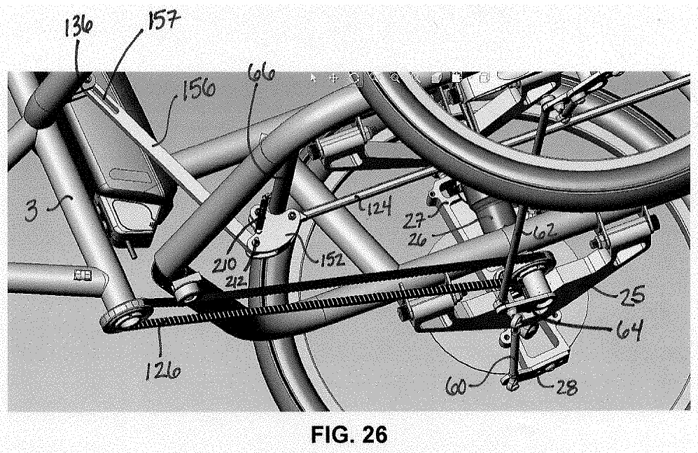

The bike has a kickstand mount tube 66 extending from the lower right frame tube 2A to the center lower tube 2C. In alternative embodiments, the kickstand mount tube 66 can be placed on the left side of the cargo frame 102 or elsewhere on the bike frame. The bike has a kickstand pushrod 124 interconnected to a kickstand 125. The kickstand 125 is interconnected to a kickstand front pivot 130 fixed to the lower front tube 2D. The kickstand pushrod 124 extends from the lower front tube 2D to the kickstand mount tube 66, but the kickstand pushrod 124 is actually interconnected on a second end (162 in FIG. 19) to the kickstand 125 and interconnected on a first end (160 in FIG. 19) to a kickstand rocker 152, which is interconnected to the kickstand mount tube 66 and the kickstand lever 156 (illustrated in FIG. 22). The kickstand lever 156 is also interconnected to the kickstand lever pivot 136, which is described in more detail with FIGS. 17 and 26. The purpose of the kickstand pushrod 124 is to lower the kickstand from the stored position into the extended position of use and to raise the kickstand back into the stored position. The user pulls up on the handle interconnected to the upper end of the kickstand lever 156, which operates the kickstand pushrod 124, which pushes the kickstand 125 toward the ground (e.g., downward) and into the extended position of use. Because the three-wheeled bike is front loaded when cargo is positioned in the cargo storage area 94, the bike may teeter-tot or tip over when the user gets off of the bike, depending on the amount of weight in the cargo storage area 94. Thus, the user can lower the kickstand 125 prior to getting off of the bike and the kickstand 125 prevents the bike from tipping over. In the embodiment shown, the handle on the upper end of the kickstand lever 156 is positioned proximate to the steering handle bars and the seat, such that it is close to the user riding the bike. In the embodiment shown, the kickstand 125 is positioned on a front end of the bike frame 100 such that it can counterbalance the heavy front end of the tipping bike. However, in additional or alternative embodiments, the kickstand lever 156 and the kickstand 125 can be positioned in other locations.

The bike also has rods 60 (also called “tie rods” or “short tie rods” herein) interconnected on one end to the kingpin connection plate 28 and on another end to the steering swivel arm 64. Further, the pushrod tube 62 (also called the “center tie rod” herein) is interconnected on one end to the right steering swivel arm 64 and interconnected on the other end to the left steering swivel arm 64. The pushrod tube 62 moves the right steering swivel arm 64 and left steering swivel arm 64 together, which moves the left short tie rod 60 and the right short tie rod 60 such that the tie rods 60, 62 move together and turn together. The tie rods 60, 62 and steering swivel arms 64 work with other components to turn the wheels 54. Having three tie rods 60, 62, instead of one tie rod, allows for some give in the turn and permit the bike to turn better than in prior art designs.

In further embodiments, the bike has a steering belt 126, which can be a carbon belt in some embodiments and is a Gates carbon belt in still further embodiments. The steering belt 126 is interconnected on one end to a sprocket interconnected to the bottom of the steering column 3 and interconnected on a second end to a sprocket proximate the left side of the cargo frame 102 and positioned above and/or interconnected to the left steering swivel arm 64. The purpose of the steering belt 126 is to assist in steering the bike and turning the tires. It has advantages over the prior art in that it replaces components of the prior art designs, which reduces manufacturing time and cost. Additionally, carbon belt is easily maintenance, lasts up to seven times longer than a traditional chain, and is oil- and grease-free. The steering belt 126 turns the sprocket proximate the left wheel, which turns (i.e., rotates) the left steering swivel arm 64, which moves both the left short tie rod 60 and the center tie rod 62. The center tie rod 62 then rotates the right steering swivel arm 64, which moves the right short tie rod 60. The short tie rods 60 are interconnected to the bottoms of the kingpins 27 via kingpin connection plates 28. Thus, the short tie rods 60 move the kingpins 27, which turn the wheels 54 and turn the bike.

FIG. 17 is a front perspective view of the cargo frame 102 according to an embodiment of the present invention. Here, the a-arm mounts 17 interconnected to the bottom surface of the upper side tubes 1A, 1B and the a-arm mounts 17 interconnected to the bottom surface of the lower side tubes 2A, 2B are visible. Additionally, the shock mounts 23 interconnected to the bottom surface of the upper side tubes 1A, 1B can also be seen. In some embodiments, the center lower tube 2C has an endcap 146 to close the center lower tube 2C. Additionally, curved upper tubes 1C can interconnect the upper front tubes 1 and the upper right tube 1A or the upper left tube 1B in some embodiments. Curved lower tubes 2G can interconnect the lower front tubes 2E and the lower right tube 2A or the lower left tube 2B in some embodiments.

In some embodiments, the cargo frame 102 has a kickstand mount tube 66 to which the kickstand (not shown in FIG. 17) is mounted. The kickstand mount tube 66 can be a tube of the same material as the other tubes forming the cargo frame or it can be a different material in alternative embodiments. The kickstand mount tube 66 can be interconnected to the lower side tube 2A (or 2B) or the lower angled tube 2G and the center lower tube 2C via known methods in the art, including welding, adhesion, gluing, soldering, etc. The cargo frame 102 can also have a kickstand front pivot 130 interconnected to the front lower tube 2D proximate the center lower tube 2C. The kickstand front pivot 130 is shown in phantom lines because it is not actually visible in the view shown in FIG. 17. The kickstand front pivot 130 is positioned on the rear lower side of the front lower tube 2D and interconnects to the kickstand 125. Additionally, the kickstand front pivot 130 is interconnected to the kickstand 125 and permits the kickstand to rotate down into the extend position of use and rotate up into the stored position. The kickstand front pivot 130 can be positioned in a different location in other embodiments if the kickstand is positioned in a different location. The cargo frame 102 can also have a kickstand spring tab 132 positioned on and/or interconnected to the kickstand mount tube 66 proximate to a kickstand rocker pivot mount 134, which is also positioned on and/or interconnected to the kickstand mount tube 66. The kickstand spring tab 132 is provided to interconnect to a first end of a spring, which is interconnected on a second end to a pin positioned through an aperture in an end of the kickstand lever 156 and an aperture in an end of the kickstand rocker 152. The kickstand spring tab 132 can be positioned in a different location in other embodiments if the kickstand 125 is positioned in a different location. The kickstand rocker pivot mount 134 is provided to interconnect the kickstand rocker 152 to the kickstand mount tube 66, and can be positioned in a different location in other embodiments if the kickstand 125 is positioned in a different location. In some embodiments, the cargo frame 102 can also have a kickstand lever pivot 136 positioned on and/or interconnected to the upper rear tube 1. The kickstand lever pivot 136 holds the kickstand lever 156 (FIG. 26) and the kickstand lever 156 slides along the kickstand lever pivot 136 to move the kickstand pushrod 124 and kickstand 125. The kickstand lever pivot 136 can be positioned in a different location in other embodiments if the kickstand is positioned in a different location. In some embodiments, the kickstand 125 is not interconnected to a kickstand pushrod 124 and/or kickstand lever 156.

In some embodiments, the cargo frame 102 comprises multiple cable guides 140 that hold the braking cables and/or cables to power the lights. In some embodiments, the bike comprises front and/or rear lights. The lights can be cord-less and battery operated or can be interconnected to a battery bike battery 120, 122 via cables. Additionally, the cargo frame 102 can have one or more steering swivel points 142 positioned on a bottom or under surface of a lower side tube, specifically the lower right tube 2A and the lower left tube 2B in the embodiment shown. The steering swivel point 142 interconnects to a tube or pin that is interconnected on one end to the steering swivel point 142 and interconnected on a second end to the steering swivel arm 64. The cargo frame 102 can also have a belt tension mount 144 interconnected to a bottom surface of and proximate the rear of the center lower tube 2C. The steering belt 126 rolls or slides along the belt tension mount 144 and the belt tension mount 144 pushes on the steering belt 126 to ensure the steering belt 126 is taught. The belt tension mount 144 can be cylindrical shaped and rotate with the steering belt 126.

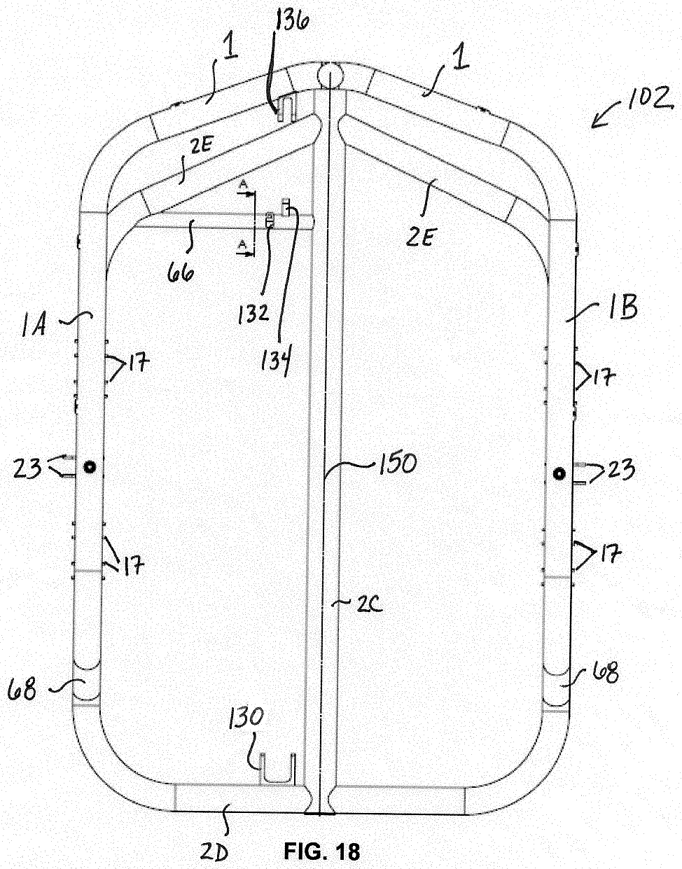

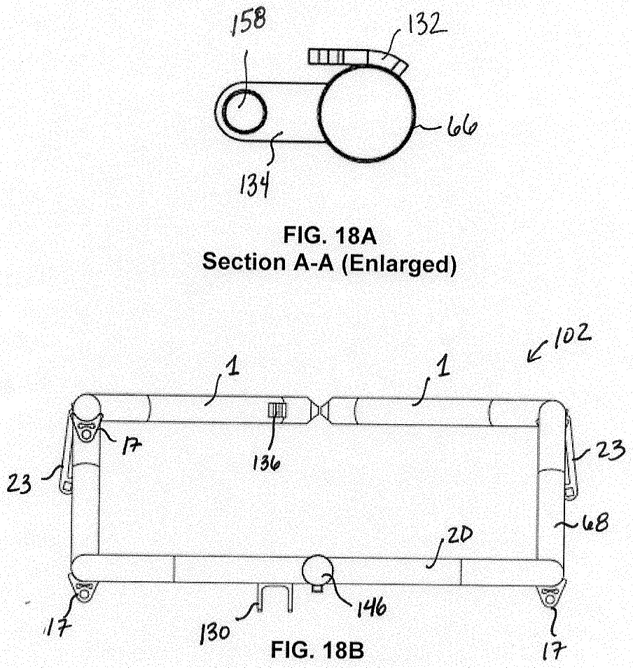

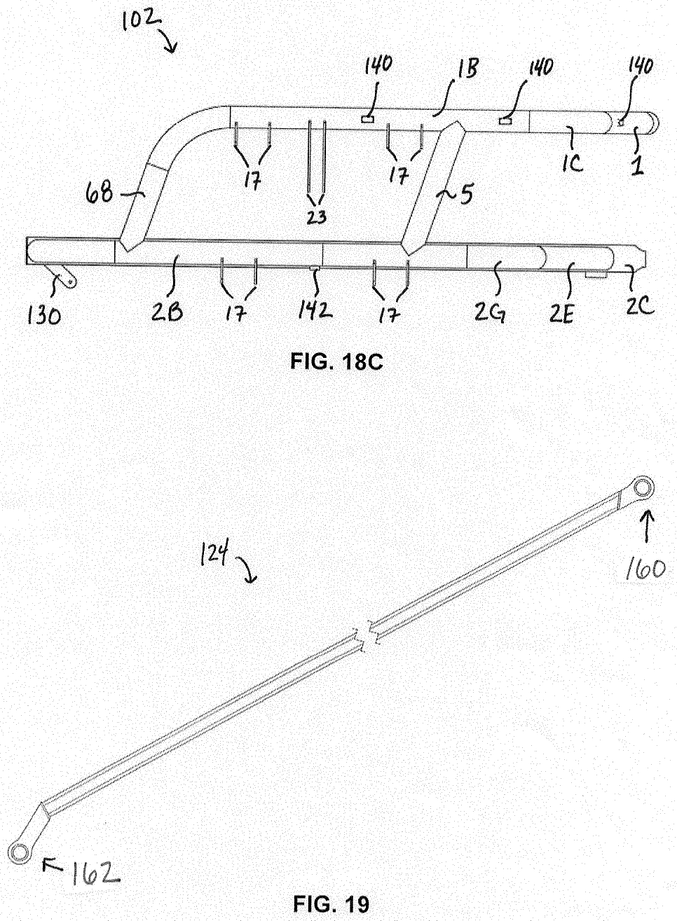

FIG. 18 is a top plan view of the cargo frame 102 according to embodiments of the present invention. The shapes and locations of the kickstand lever point 136 and the kickstand front pivot 130 can be seen. The longitudinal centerline 150 of the cargo frame 102 is also the centerline of the center lower tube 2C.

FIG. 18A is a cross-section of the kickstand mount tube 66 taken along line A-A of FIG. 18. In some embodiments, a kickstand spring tab 132 is positioned on and/or interconnected to the top surface of the kickstand mount tube 66 proximate to a kickstand rocker pivot mount 134, which is positioned on and/or interconnected to a rear surface of the kickstand mount tube 66. The kickstand rocker pivot mount 134 has an aperture 158 through which a fastener (e.g., pin, screw, bolt, etc.) is positioned to interconnect the kickstand rocker 152 to the kickstand mount tube 66.

FIG. 18B is a front elevation view of the cargo frame 102 and FIG. 18C is a left side elevation view of the cargo frame 102. The location and position of the kickstand front pivot 130, cable guides 140, and steering swivel point 142 can be seen in these views.

FIG. 19 shows the kickstand pushrod 124 according to some embodiments of the present invention. The kickstand pushrod 124 has a first end 160 and a second end 162 opposite the first end 160. The first end 160 is interconnected to the kickstand rocker 152 and the second end 162 is interconnected to the kickstand 125. As discussed above, the kickstand pushrod 124 rotates the kickstand 125 down into the extended position of use and rotates the kickstand 125 up into the stored position.

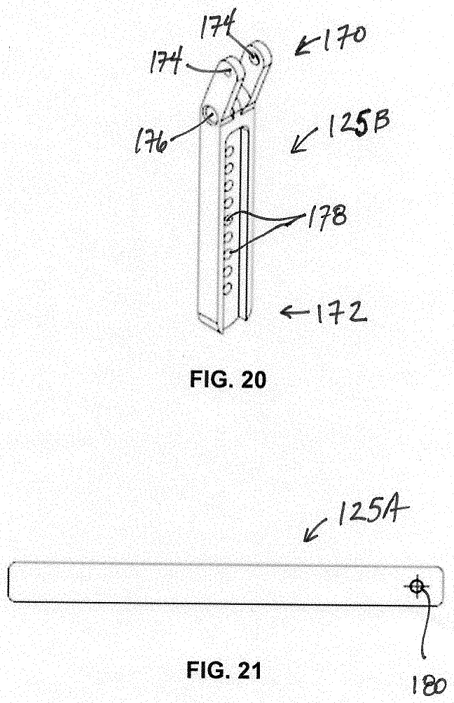

FIGS. 20 and 21 show the two components that make up the kickstand: the kickstand lower portion 125A the kickstand upper portion 125B. The kickstand lower portion 125A and kickstand upper portion 125B are connected to form the kickstand 125. The kickstand upper portion 125B has two apertures 174 proximate a first end 170 where the kickstand upper portion 125B interconnects to the second end 162 of the kickstand pushrod 124 via a fastener, e.g., a screw, a bolt, a pin, etc. The kickstand upper portion 125B has two additional apertures 176 where the kickstand upper portion 125B interconnects to the kickstand front pivot 130 via a fastener, e.g., a screw, a bolt, a pint, etc. The kickstand upper portion 125B also has a plurality of apertures 178 positioned between the first end 170 and second end 172. The kickstand lower portion 125A has an aperture 180 to interconnect to the kickstand upper portion 125B via a fastener positioned through one of the apertures in the plurality of apertures 178.

FIG. 22 is a kickstand lever 156 according to some embodiments of the present invention. The kickstand lever 156 has a slot 157 proximate one end. The slot 157 receives a pin, bolt, or other fastener that is interconnected to the kickstand lever pivot 136 (FIG. 18). The kickstand lever 156 can slide up and down because the pin, bolt, or other fastener can slide along the slot 157.

FIG. 23 illustrates a kickstand rocker 156 to embodiments of the present invention. The kickstand rocker 152 has a first pair of apertures 182, a second pair of apertures 184, and a third pair of apertures 186. The first pair of apertures 182 receive a pin, bolt, screw, or other fastener to interconnect to the kickstand rocker pivot mount 134. The second pair of apertures 184 receive a pin, bolt, screw, or other fastener to interconnect to the first end 160 of the kickstand pushrod 124. The third pair of apertures 186 receive a pin, bolt, screw, or other fastener to interconnect to the lower end of the kickstand lever 156. The pin, bolt, screw, or other fastener can extend outward from one of the apertures in the third pair of apertures 186 to receive and/or interconnect to one end of the spring, which is interconnected on a second end to the kickstand spring tab 132.

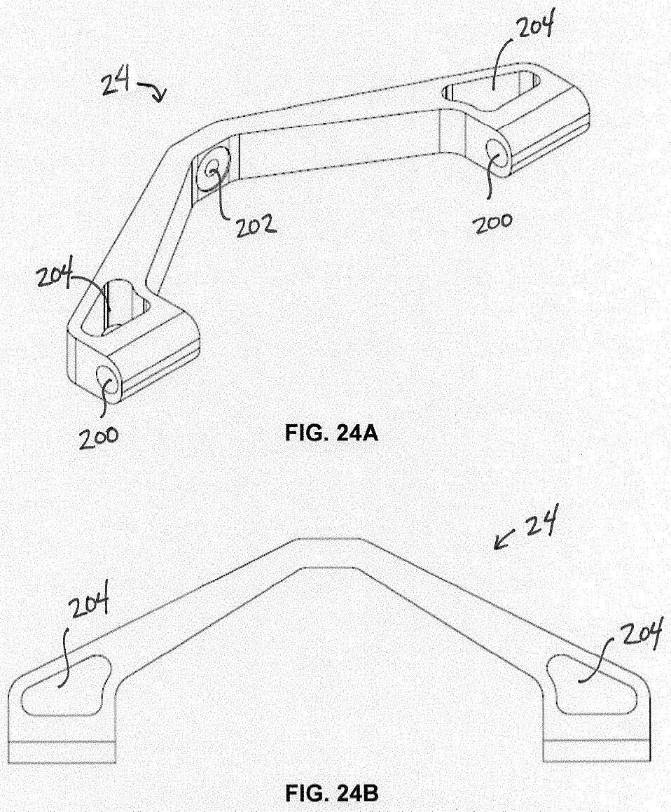

FIG. 24A is a perspective view of an upper a-arm 24 and FIG. 24B is a top plan view of the upper a-arm 24 according to embodiments of the present invention. The upper a-arm 24 can have two longitudinal apertures 200, a kingpin aperture 202, and one or more cutouts 204. The longitudinal apertures 200 receive the fasteners 18 to interconnect to the a-arm mounts 17. The upper multidirectional super-swivel ball joint 22 interconnected to the kingpin 27 is bolted to the upper a-arm 24 via the kingpin aperture 202. The one or more cutouts 204 are provided to reduce the weight of the a-arm 24. The cutouts 204 can be any shape and positioned in alternative locations. As shown in FIG. 6, the upper a-arm 24 can be positioned a distance 34 behind (rearward) the lower a-arm 25.

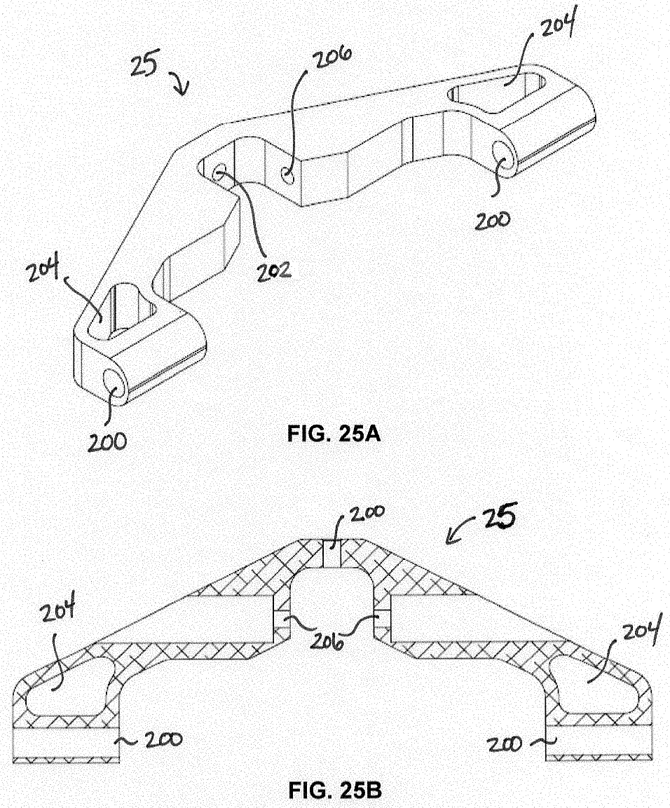

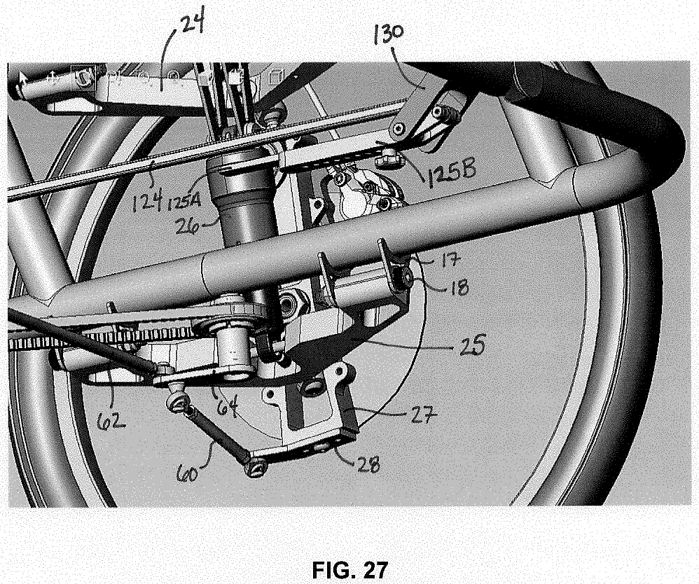

FIG. 25A is a perspective view of a lower a-arm 25 and FIG. 25B is a cross sectional top view of the lower a-arm 24 according to embodiments of the present invention. The lower a-arm 25 comprises two longitudinal apertures 200, a kingpin aperture 202, one or more cutouts 204, and two shock pin apertures 206. The longitudinal apertures 200 receive the fastener 18 to interconnect to the a-arm mounts 17. The lower multidirectional super-swivel ball joint 22 interconnected to the kingpin 27 is bolted to the lower a-arm 25 via the kingpin aperture 202. The one or more cutouts 204 are provided to reduce the weight of the a-arm 25. The cutouts 204 can be any shape and positioned in alternative locations. The lower a-arm 25 also has two shock pin apertures 206 to receive a pin or tube to which the bottom of the shock 26 is interconnected (illustrated in FIG. 27). The lower a-arm 25 handles more load (i.e., weight and/or forces) than the upper a-arm 24 because the lower a-arm 25 is also interconnected to the shock 26. Thus, the lower a-arm 25 can be heavier and/or bulkier to handle the additional load.

FIG. 26 is a perspective inside view of the first end 160 of the kickstand pushrod 124, the left lower a-arm 25, and the steering belt 126 according to embodiments of the present invention. As seen in this view, the steering belt 126 is interconnected on one end to a sprocket positioned at a bottom end of the steering column and interconnected on the opposite end to a sprocket interconnected to a steering swivel point 142 interconnected to a bottom surface of the left side lower tube 2B. The sprocket proximate the left wheel is also interconnected to or positioned around a tube interconnected to one end of the steering swivel arm 64. The upper surface of the opposite end of the steering swivel arm 64 is interconnected to the center tie rod and the lower surface of that same end of the steering swivel arm 64 is interconnected to the short left tie rod 60. Also shown in this view is the kickstand rocker 152 interconnected to the kickstand mount tube 66, kickstand lever 156, kickstand pushrod 124, and the spring 210. The spring 210 is drawn slightly too short and should extend to the pin 212 in the kickstand rocker 152. The slot 157 in the kickstand lever 156 is interconnected to the kickstand lever point 136 via a pin, screw, bolt, or other fastener.

FIG. 27 is a perspective inside view of the second end 162 of the kickstand pushrod 124, kickstand 125, the left lower a-arm 25, and left shock 26 according to embodiments of the present invention. Here, the center tie rod 62 and short left tie rod 60 are shown interconnected to the left steering swivel arm 64. The kickstand pushrod 124 is interconnected to the kickstand upper portion 125B, which is interconnected to the kickstand lower portion 125A. The kickstand upper portion 125B is interconnected to the kickstand front pivot 130. The kickstand 125 has the two components 125A, 125B such that the kickstand length is adjustable. In some embodiments, when the kickstand 125 is lowered it does not touch the ground initially, i.e., the bottom end of the kickstand 125 is positioned a distance away from the ground. Rather, the kickstand 125 only touches the ground when the bike shifts or starts to teeter-tot and then the kickstand 125 prevents the bike from tipping over. The user may want a longer or shorter kickstand 125 depending on the cargo being carried in the cargo storage area 94. In some embodiments, the kickstand 125 may be long enough that when it is released, it contacts the ground and raises the bike wheels/tires off of the ground. In further embodiments, the kickstand 125 can be a double kickstand (i.e., have two legs) to further assist in raising the wheels/tires off of the ground when the kickstand is deployed. The frame as described herein is illustrated in several pieces. However, the frame could be made of a single piece without deviating from the invention. Furthermore, in some embodiments, it is advantageous for the frame to be made of multiple pieces so that the bike can be disassembled or be collapsible, allowing for easy storage of the bike and further allowing the bike to become compact when not in use.

Ranges have been discussed and used within the forgoing description. One skilled in the art would understand that any sub-range within the stated range would be suitable, as would any number within the broad range, without deviating from the invention.

Accordingly, the present invention has been described with some degree of particularity directed to the exemplary embodiments of the present invention. It should be appreciated though that modifications or changes may be made to the exemplary embodiments of the present invention without departing from the inventive concepts contained herein.

The foregoing description of the bike and the components thereof of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A two-tiered vehicle frame, comprising:
a top tube;
a bottom tube;
a steering post, wherein the top tube extends from a front of the frame to the steering post and the bottom tube extends from the front of the frame to a location proximate the steering post;
at least one rear tube;
a seat post, wherein the at least one rear tube connects the steering post to the seat post;
a rear triangle, wherein the rear triangle connects to the seat post and to a rear wheel;
a cargo storage area located proximate the front of the frame and between a first side of the frame and a second side of the frame; and
a steering system comprising:
a first upper a-arm, wherein the first upper a-arm is located on a right portion of the top tube;
a first bottom a-arm, wherein the first bottom a-arm is located on a right portion of the bottom tube;
a second upper a-arm, wherein the second upper a-arm is located on a left portion of the top tube and opposite from the first upper a-arm;
a second bottom a-arm, wherein the second bottom a-arm is located on a left portion of the bottom tube and opposite from the first bottom a-arm;
a first kingpin, wherein the first kingpin is interconnected to the first upper a-arm and the first bottom a-arm;
a second kingpin, wherein the second kingpin attaches between the second upper a-arm and the second bottom a-arm;
a first tie rod interconnected to a bottom of the first kingpin;
a second tie rod interconnected to a bottom of the second kingpin;
a first steering swivel arm interconnected to the first tie rod;
a second steering swivel arm interconnected to the second tie rod;
a center tie rod interconnected on one end to the first steering swivel arm and interconnected on an opposite end to the second steering swivel arm; and
a belt interconnected to the steering post and the second steering swivel arm.

2. The two-tiered vehicle frame of claim 1, wherein a material for at least one of the top tube, the bottom tube, the steering post, the at least one rear tube, the seat post, the rear triangle, the first upper a-arm, the first bottom a-arm, the second bottom a-arm, the second bottom a-arm, the first kingpin, or the second kingpin is selected from the group consisting of aluminum, titanium, steel, alloys thereof, a composite material, and combinations thereof.

3. The two-tiered vehicle frame of claim 1, further comprising a kickstand system.

4. The two-tiered vehicle frame of claim 3, wherein the kickstand system comprises:
a kickstand interconnected to the bottom tube;
a kickstand pushrod with a first end interconnected to the kickstand; and
a kickstand lever interconnected on a first end to the kickstand pushrod and interconnected on a second end to the top tube.

5. The two-tiered vehicle frame of claim 1, further comprising at least one support tube.

6. The two-tiered vehicle frame of claim 1, further comprising:
a first shock interconnected on an upper end to the right portion of the top tube and interconnected on a lower end to the first bottom a-arm; and
a second shock interconnected on an upper end to the left portion of the top tube and interconnected on a lower end to the second bottom a-arm.

7. A bike, comprising:
a forward end;
a rear end;
a first forward wheel proximate the forward end, wherein the first forward wheel can turn right and left;
a second forward wheel proximate the forward end, wherein the second forward wheel can turn right and left;
a rear wheel proximate the rear end, wherein the rear wheel is fixed and cannot turn;
a frame comprising:
an upper right tube proximate the forward end of the bike;
an upper left tube proximate the forward end of the bike;
an upper tube positioned between and interconnected to the upper right tube and the upper left tube;
a lower right tube proximate the forward end of the bike;
a lower left tube proximate the forward end of the bike;
a lower tube positioned between and interconnected to the lower right tube and the lower left tube;
a lower center tube positioned between and substantially parallel to the lower right tube and the lower left tube and interconnected to the lower tube;
a kickstand mount tube interconnected on one end to the lower right tube and interconnected on an opposite end to the lower center tube;
a steering column positioned behind the upper tube and the lower tube;
a rear tube interconnected to the steering column and extending rearward;
a seat post interconnected to the rear tube; and
a rear triangle comprising two or more small tubes and extending rearward from the seat post, wherein the rear wheel is interconnected to the rear triangle; and
a kickstand system comprising:
a kickstand interconnected to the lower tube;
a kickstand pushrod with a first end interconnected to the kickstand;
a kickstand rocker interconnected to a second end of the kickstand pushrod and the kickstand mount tube; and
a kickstand lever interconnected on a first end to the kickstand rocker and interconnected on a second end to the upper tube.

8. The bike of claim 7, further comprising a spring interconnected to the kickstand mount tube and the kickstand rocker.

9. The bike of claim 7, further comprising a first kingpin and a second king pin, wherein the first and second kingpins permit the first and second forward wheels to turn at different angles relative to a longitudinal axis of the bike at the same time when the bike is turning.

10. The bike of claim 9, wherein the first kingpin is interconnected to a first upper a-arm on an upper end of the first kingpin and the first upper a-arm is interconnected to the upper right tube, and wherein the first kingpin is interconnected to a first lower a-arm on a lower end of the first kingpin and the first lower a-arm is interconnected to the lower right tube.

11. The bike of claim 10, wherein the second kingpin is interconnected to a second upper a-arm on an upper end of the second kingpin and the second upper a-arm is interconnected to the upper left tube, and wherein the second kingpin is interconnected to a second lower a-arm on a lower end of the second kingpin and the second lower a-arm is interconnected to the lower left tube.

12. The bike of claim 10, further comprising:
a first tie rod interconnected to a bottom of the first kingpin;
a second tie rod interconnected to a bottom of the second kingpin;
a first steering swivel arm interconnected to the first tie rod;
a second steering swivel arm interconnected to the second tie rod;
a center tie rod interconnected on one end to the first steering swivel arm and interconnected on an opposite end to the second steering swivel arm; and
a belt interconnected to the steering column and the second steering swivel arm.

13. The bike of claim 7, wherein a material for at least one of the upper right tube, the upper left tube, the lower right tube, the lower left tube, the upper tube, and the lower tube is selected from the group consisting of aluminum, titanium, steel, an alloy thereof, a composite material, and combinations thereof.

14. The bike of claim 7, further comprising a cargo area proximate the forward end, wherein the cargo area has an open front end and a closed rear end.

15. The bike of claim 7, wherein when the bike is turning and the first forward wheel is an inside wheel in a turn, the first forward wheel turns at a greater angle than the second forward wheel, which is an outside wheel in the turn, such that neither wheel slips in a turn.

16. A bike, comprising:
a frame;
three wheels; and
a steering system, wherein at least one wheel of the three wheels is connected to the steering system, wherein the steering system comprises a belt interconnected to a steering column of the steering system.
